(19) United States
(12) Patent Application Publication
(10) Pub. No.: US 2020/0051559 A1
(43) Pub. Date: Feb. 13, 2020

(54) ELECTRONIC DEVICE AND METHOD FOR PROVIDING ONE OR MORE ITEMS IN RESPONSE TO USER SPEECH

(71) Applicant: Samsung Electronics Co., Ltd., Suwon-si (KR)

(72) Inventors: Suneung PARK, Suwon-si (KR); Taekwang UM, Suwon-si (KR); Jaeyung YEO, Suwon-si (KR)

(21) Appl. No.: 16/534,168

(22) Filed: Aug. 7, 2019

(30) Foreign Application Priority Data
Aug. 8, 2018 (KR) 10-2018-0092696

(51) Int. Cl. G10L 15/22; G06F 17/27; G06F 16/9032

(52) U.S. Cl. CPC G10L 15/22; G10L 2015/223; G06F 16/90332; G06F 17/278

(57) ABSTRACT

An electronic device for providing one or more items to a user in response to a user speech and a system therefor are provided. The electronic device and the system search one or more items in response to a user's voice command related with a search of an item. In case where items are searched, a user performs various activities related with the items. The items each include objects. The electronic device and the system identify an object that is used when the user identifies at least one item (for example, an item preferred by the user) among the items from the activity. By matching the identified object and a feature of the identified object, the electronic device and the system determine a user's preference related with a search of an item. The identified preference is used for sorting of the items.

### CROSS-REFERENCE TO RELATED APPLICATION(S)

This application is based on and claims priority under 35 U.S.C. § 119 of a Korean patent application number 10-2018-0092696, filed on Aug. 8, 2018, in the Korean Intellectual Property Office, the disclosure of which is incorporated by reference herein in its entirety.

### BACKGROUND

### 1. Field

The disclosure relates to an apparatus providing one or more items to a user in response to a user speech and a system including the apparatus.

### 2. Description of Related Art

In case where a user uses an internet shopping service, various products can be outputted as items. The user can sort the outputted goods by using criterions (for example, a price zone, a color, a product type, a store, ascending order of price, descending order of price, order of registration date, and/or ascending order of product reviews) provided by a service provider. The service provider can decide in which layout to deliver item related information to the user. In the aforementioned example of the internet shopping service, the user can identify prices and/or ratings of the products according to the layout decided by the service provider.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an apparatus providing one or more items to a user in response to a user speech and a system including the apparatus.

In case where a user sorts a variety of items outputted in a service provided through an electronic device, a criterion of sorting the items can be restricted by a service provider. Accordingly, a solution for the user to change the criterion of sorting the items suitably to a user's intention can be demanded.

Technological solutions the disclosure seeks to achieve are not limited to the above-mentioned technological solutions, and other technological solutions not mentioned above would be able to be clearly understood by a person having ordinary skill in the art from the following statement.

Additional aspects will be set forth in part in the description which follows and, in part, will be apparent from the description, or may be learned by practice of the presented embodiments.

In accordance with an aspect of the disclosure, an electronic device is provided. The electronic device includes a display, at least one communication circuitry, a microphone, at least one speaker, at least one processor operatively coupled to the display, the communication circuitry, the microphone, and the speaker, and at least one memory electrically coupled to the processor. The memory is configured to store an application program including a user interface. The memory stores instructions, when executed, enables the at least one processor to display the user interface on the display wherein the user interface includes one or more objects, and receive a first user input of selecting one object among the objects, and transmit first information related to the selected object to an external server, through the communication circuitry, and receive second information about one or more attributes of the selected object from the external server, through the communication circuitry, to display the received second information on the user interface, and receive a second user input of selecting at least one attribute among the attributes, and transmit third information related to the selected attribute to the external server, through the communication circuitry.

In accordance with another aspect of the disclosure, a system is provided. The system includes a communication interface, at least one processor operatively coupled with the communication interface, and at least one memory electrically coupled to the at least one processor. The memory stores instructions, when executed, enables the at least one processor to receive, from an electronic device displaying a user interface comprising one or more objects on a display, a request for first information about one or more attributes related with an object selected among the objects, through the communication interface, and in accordance with the request for the first information, transmit the first information to the electronic device through the communication interface, and receive a request for second information related with at least one attribute selected among the one or more attributes, from the electronic device through the communication interface, and in accordance with the request for the second information, transmit the second information to the electronic device through the communication interface.

In accordance with another aspect of the disclosure, an electronic device is provided. The electronic device includes a memory configured to store a voice signal obtained from a user, a display configured to output a user interface related with the user, and at least one processor. The at least one processor is configured to in response to the voice signal, display, on the basis of a first sequence, a plurality of items in the user interface, the plurality of items each comprising at least one visual object, the user interface comprising at least one executable object displayed together with the plurality of items and for changing the first sequence, and in a designated operation mode of the user interface, in response to a user's input of selecting the at least one executable object, display, in the user interface, the plurality of items on the basis of a second sequence indicated by the selected object, and in the designated operation mode, in response to a user's input of selecting any one visual object among the at least one visual object, display, in the user interface, the plurality of items on the basis of a third sequence distinguished from the first sequence and the second sequence.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an integrated intelligence system according to an embodiment of the disclosure;

FIG. 2 is a diagram illustrating a form in which relationship information between a concept and an action is stored in a database, according to an embodiment of the disclosure;

FIG. 3 is a diagram illustrating a user terminal displaying a screen of processing a voice input received through an intelligence app, according to an embodiment of the disclosure;

FIG. 4 is a block diagram of an electronic device within a network environment, according to an embodiment of the disclosure;

FIG. 5 is a diagram for explaining structures of an electronic device and a system according to an embodiment of the disclosure;

FIG. 6 is a diagram conceptually illustrating a hardware component or software component that a system uses in order to manage a preference according to an embodiment of the disclosure;

FIG. 7 is a flowchart for explaining an operation in which an electronic device or a system sorts a plurality of items provided to a user by using a preference object according to an embodiment of the disclosure;

FIGS. 8A, 8B and 8C are example diagrams for explaining a user interface (UI) that an electronic device provides to a user according to various embodiments of the disclosure;

FIGS. 9A, 9B and 9C are example diagrams for explaining an operation in which an electronic device requests a user to select at least one of a plurality of attributes or features of an object selected by the user according to various embodiments of the disclosure;

FIGS. 10A and 10B are example diagrams for explaining an operation in which an electronic device changes a sequence of arranging a plurality of items in a display by using a preference object generated on the basis of a user input according to various embodiments of the disclosure;

FIG. 11 is an example diagram for explaining a structure of a preference object managed by an electronic device or system according to an embodiment of the disclosure;

FIG. 12 is a signal flowchart for explaining interaction between an electronic device and systems according to an embodiment of the disclosure;

FIG. 13 is a diagram for explaining an operation in which a system identifies a preference from a user according to an embodiment of the disclosure;

FIGS. 14A, 14B and 14C are diagrams for explaining an operation in which an electronic device changes a sequence of a plurality of items on the basis of a preference obtained from a user according to various embodiments of the disclosure;

FIG. 15 is a diagram for explaining an operation in which a system coupled with a plurality of content providing devices shares a preference object related with any one of the plurality of content providing devices according to an embodiment of the disclosure;

FIG. 16 is an example diagram for explaining an operation in which a system shares a preference between a plurality of content providing devices according to an embodiment of the disclosure;

FIGS. 17A and 17B are example diagrams for explaining an operation in which an electronic device shares a preference between a plurality of applications related with each of a plurality of content providing devices according to various embodiments of the disclosure;

FIGS. 18A and 18B are example diagrams for explaining an operation in which an electronic device outputs a preference object to a user according to various embodiments of the disclosure;

FIG. 19 is a diagram illustrating an example of a user interface that an electronic device provides to a user in order to identify a preference object according to an embodiment of the disclosure;

FIG. 20 is a flowchart for explaining an operation of an electronic device according to an embodiment of the disclosure;

FIG. 21 is a flowchart for explaining an operation of a system according to an embodiment of the disclosure; and

FIG. 22 is a flowchart for explaining an operation in which a system obtains a score related with an attribute of an object identified from a user of an electronic device according to an embodiment of the disclosure.

Throughout the drawings, it should be noted that like reference numbers are used to depict the same or similar elements, features, and structures.

### DETAILED DESCRIPTION

The following descriptions with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The terms of first, second or the like may be used to explain various constituent elements, but these terms should be interpreted only for the purpose of distinguishing one constituent element from another constituent element. For example, a first constituent element may be named a second constituent element and similarly, a second constituent element may be named a first constituent element as well.

When it is mentioned that any constituent element is “coupled” to another constituent element, the any constituent element may be directly coupled or connected to the another constituent element as well, but it should be understood that a further constituent element may exist in the middle as well.

The expression of a singular form includes the expression of a plural form unless otherwise dictating clearly in context. In the specification, it should be understood that the term “include”, “have” or the like is to designate the existence of explained features, numerals, steps, operations, constituent elements, components or a combination of them, and does not previously exclude the possibility of existence or addition of one or more other features, numerals, steps, operations, constituent elements, components or combinations of them.

Unless defined otherwise, all the terms used herein including the technological or scientific terms have the same meanings as those generally understood by a person having ordinary skill in the art. The terms such as defined in a generally used dictionary should be construed as having meanings coinciding with the contextual meanings of a related technology, and are not construed as having ideal or excessively formal meanings unless defined clearly in the specification.

Embodiments are explained below in detail with reference to the accompanying drawings. The same reference numeral presented in each of the drawings indicates the same member.

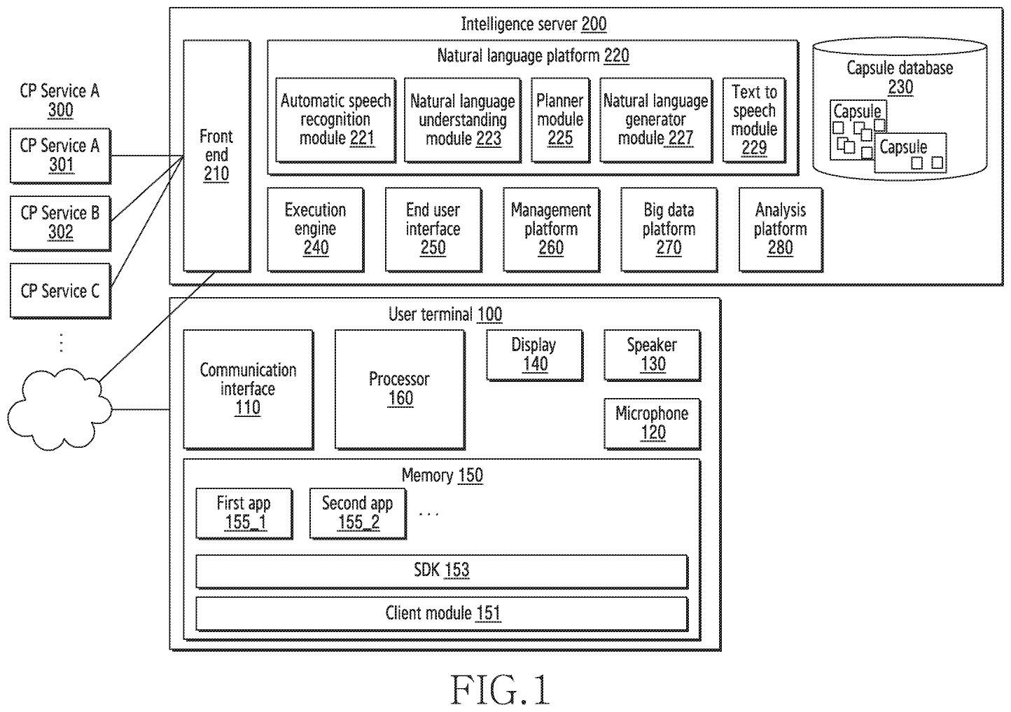

FIG. 1 is a block diagram illustrating an integrated intelligence system according to an embodiment of the disclosure.

Referring to FIG. 1, the integrated intelligence system 10 of an embodiment may include a user terminal 100, an intelligence server 200, and a service server 300.

The user terminal 100 of an embodiment may be a terminal device (or an electronic device) possible to be coupled to the Internet and, for example, may be a portable phone, a smart phone, a personal digital assistant (PDA), a notebook computer, a television (TV), a home appliance, a wearable device, a head mounted device (HMD), or a smart speaker.

According to an embodiment illustrated, the user terminal 100 may include a communication interface 110, a microphone 120, a speaker 130, a display 140, a memory 150, or a processor 160. The enumerated constituent elements may be operatively or electrically coupled with each other.

The communication interface 110 of an embodiment may be configured to be coupled with an external device and transmit and/or receive data with the external device. The microphone 120 of an embodiment may receive a sound (e.g., a user utterance) and convert the sound into an electrical signal. The speaker 130 of an embodiment may output an electrical signal as a sound (e.g., a voice). The display 140 of an embodiment may be configured to display an image or video. The display 140 of an embodiment may also display a graphic user interface (GUI) of an executed app (or application program).

The memory 150 of an embodiment may store a client module 151, a software development kit (SDK) 153, and a plurality of apps 155. The client module 151 and the SDK 153 may configure a framework (or solution program) for performing a generic function. Also, the client module 151 or the SDK 153 may configure a framework for processing a voice input.

The plurality of apps 155 stored in the memory 150 of an embodiment may be a program for performing a designated function. According to an embodiment, the plurality of apps 155 may include a first app 155_1 and a second app 155_2. According to an embodiment, the plurality of apps 155 may each include a plurality of actions for performing a designated function. For example, the apps may include an alarm app, a message app, and/or a schedule app. According to an embodiment, the plurality of apps 155 may be executed by the processor 160, and execute at least some of the plurality of actions in sequence.

The processor 160 of an embodiment may control a general operation of the user terminal 100. For example, the processor 160 may be electrically coupled with the communication interface 110, the microphone 120, the speaker 130, and the display 140, and perform a designated operation.

The processor 160 of an embodiment may also execute a program stored in the memory 150, and perform a designated function. For example, the processor 160 may execute at least one of the client module 151 or the SDK 153, and perform a subsequent operation for processing a voice input. The processor 160 may, for example, control operations of the plurality of apps 155 through the SDK 153. An operation of the client module 151 or the SDK 153 explained in the following may be an operation by the execution of the processor 160.

The client module 151 of an embodiment may receive a voice input. For example, the client module 151 may receive a voice signal corresponding to a user utterance which is sensed through the microphone 120. The client module 151 may transmit the received voice input to the intelligence server 200. The client module 151 may transmit state information of the user terminal 100 to the intelligence server 200, together with the received voice input. The state information may be, for example, app execution state information.

The client module 151 of an embodiment may receive a result corresponding to the received voice input. For example, in response to the intelligence server 200 being capable of calculating the result corresponding to the received voice input, the client module 151 may receive the result corresponding to the received voice input from the intelligence server 200. The client module 151 may display the received result on the display 140.

The client module 151 of an embodiment may receive a plan corresponding to the received voice input. The client module 151 may display, on the display 140, a result of executing a plurality of actions of an app according to the plan. The client module 151 may, for example, display the result of execution of the plurality of actions in sequence on the display. The user terminal 100 may, for another example, display only a partial result (e.g., a result of the last operation) of executing the plurality of actions on the display.

According to an embodiment, the client module 151 may receive a request for obtaining information necessary for calculating a result corresponding to a voice input, from the intelligence server 200. According to an embodiment, in response to the request, the client module 151 may transmit the necessary information to the intelligence server 200.

The client module 151 of an embodiment may transmit result information of executing a plurality of actions according to a plan, to the intelligence server 200. By using the result information, the intelligence server 200 may identify that the received voice input is processed rightly.

The client module 151 of an embodiment may include a voice recognition module. According to an embodiment, the client module 151 may recognize a voice input of performing a restricted function through the voice recognition module. For example, the client module 151 may perform an intelligence app for processing a voice input for performing a systematic operation through a designated input (e.g., wake up!)

The intelligence server 200 of an embodiment may receive information related with a user voice input from the user terminal 100 through a communication network. According to an embodiment, the intelligence server 200 may convert data related with the received voice input into text data. According to an embodiment, the intelligence server 200 may generate a plan for performing a task corresponding to the user voice input on the basis of the text data.

According to an embodiment, the plan may be generated by an artificial intelligent (AI) system. The artificial intelligent system may be a rule-based system as well, and may be a neural network-based system (e.g., feedforward neural network (FNN)) and/or a recurrent neural network (RNN)) as well. Or, the artificial intelligent system may be either a combination of the aforementioned or an artificial intelligent system different from this as well. According to an embodiment, the plan may be selected in a set of predefined plans, or may be generated in real time in response to a user request. For example, the artificial intelligent system may select at least one plan among a predefined plurality of plans.

The intelligent server 200 of an embodiment may transmit a result of the generated plan to the user terminal 100, or transmit the generated plan to the user terminal 100. According to an embodiment, the user terminal 100 may display the result of the plan on the display 140. According to an embodiment, the user terminal 100 may display a result of executing an action of the plan on the display 140.

The intelligent server 200 of an embodiment may include a front end 210, a natural language platform 220, a capsule database (DB) 230, an execution engine 240, an end user interface 250, a management platform 260, a big data platform 270, or an analytic platform 280.

The front end 210 of an embodiment may receive a voice input received from the user terminal 100. The front end 210 may transmit a response corresponding to the voice input.

According to an embodiment, the natural language platform 220 may include an automatic speech recognition module (ASR module) 221, a natural language understanding module (NLU module) 223, a planner module 225, a natural language generator module (NLG module) 227 or a text to speech module (TTS module) 229.

The automatic speech recognition module 221 of an embodiment may convert a voice input received from the user terminal 100 into text data. By using the text data of the voice input, the natural language understanding module 223 of an embodiment may grasp a user's intention. For example, by performing syntactic analysis or semantic analysis, the natural language understanding module 223 may grasp the user's intention. By using a linguistic feature (e.g., syntactic factor) of a morpheme or phrase, the natural language understanding module 223 of an embodiment may grasp a meaning of a word extracted from the voice input, and match the grasped meaning of the word with the user intention, to identify the user's intention.

By using an intention and parameter identified by the natural language understanding module 223, the planner module 225 of an embodiment may generate a plan. According to an embodiment, on the basis of the identified intention, the planner module 225 may identify a plurality of domains necessary for performing a task. The planner module 225 may identify a plurality of actions included in each of the plurality of domains which are identified on the basis of the intention. According to an embodiment, the planner module 225 may identify a parameter necessary for executing the identified plurality of actions, or a result value outputted by the execution of the plurality of actions. The parameter and the result value may be defined with a concept of a designated form (or class). Accordingly to this, the plan may include the plurality of actions identified by the user's intention, and a plurality of concepts. The planner module 225 may identify a relationship between the plurality of actions and the plurality of concepts stepwise (or hierarchically). For example, on the basis of the plurality of concepts, the planner module 225 may identify a sequence of execution of the plurality of actions that are identified on the basis of the user intention. In other words, the planner module 225 may identify the sequence of execution of the plurality of actions, on the basis of the parameter necessary for execution of the plurality of actions and the result outputted by execution of the plurality of actions. Accordingly to this, the planner module 225 may generate a plan including association information (e.g., ontology) between the plurality of actions and the plurality of concepts. The planner module 225 may generate the plan by using information stored in a capsule database 230 in which a set of relationships between the concept and the action is stored.

The natural language generator module 227 of an embodiment may convert designated information into a text form. The information converted into the text form may be a form of a natural language speech. The text to voice conversion module 229 of an embodiment may convert the information of the text form into information of a voice form.

According to an embodiment, a partial function or whole function of a function of the natural language platform 220 may be implemented even in the user terminal 100.

The capsule database 230 may store information about a relationship between a plurality of concepts and actions corresponding to a plurality of domains. A capsule of an embodiment may include a plurality of action objects (or action information) and concept objects (or concept information) which are included in a plan. According to an embodiment, the capsule database 230 may store a plurality of capsules in a form of a concept action network (CAN). According to an embodiment, the plurality of capsules may be stored in a function registry included in the capsule database 230.

The capsule database 230 may include a strategy registry storing strategy information which is necessary for identifying a plan corresponding to a voice input. The strategy information may include reference information for, in response to there being a plurality of plans corresponding to a voice input, identifying one plan. According to an embodiment, the capsule database 230 may include a follow up registry storing follow-up operation information for proposing a follow-up operation to a user in a designated condition. The follow-up operation may include, for example, a follow-up utterance. According to an embodiment, the capsule database 230 may include a layout registry storing layout information of information outputted through the user terminal 100. According to an embodiment, the capsule database 230 may include a vocabulary registry storing vocabulary information included in capsule information. According to an embodiment, the capsule database 230 may include a dialog registry storing user's dialog (or interaction) information. The capsule database 230 may update an object stored through a developer tool. The developer tool may include, for example, a function editor for updating an action object or a concept object. The developer tool may include a vocabulary editor for updating a vocabulary. The developer tool may include a strategy editor generating and registering a strategy of identifying a plan. The developer tool may include a dialog editor generating a dialog with a user. The developer tool may include a follow up editor which may edit a follow up speech activating a follow up target and providing a hint. The follow up target may be identified on the basis of a currently set target, a user's preference or an environment condition. In an embodiment, the capsule database 230 may be implemented even in the user terminal 100.

The execution engine 240 of an embodiment may calculate a result by using the generated plan. The end user interface 250 may transmit the calculated result to the user terminal 100. Accordingly to this, the user terminal 100 may receive the result, and provide the received result to a user. The management platform 260 of an embodiment may manage information used in the intelligence server 200. The big data platform 270 of an embodiment may collect user's data. The analysis platform 280 of an embodiment may manage a quality of service (QoS) of the intelligence server 200. For example, the analysis platform 280 may manage a constituent element and processing speed (or efficiency) of the intelligence server 200.

The service server 300 of an embodiment may provide a designated service (e.g., food order or hotel reservation) to the user terminal 100. According to an embodiment, the service server 300 may be a server managed by a third party. The service server 300 of an embodiment may provide information for generating a plan corresponding to a received voice input, to the intelligence server 200. The provided information may be stored in the capsule database 230. Also, the service server 300 may provide result information of the plan to the intelligence server 200.

In the above-described integrated intelligence system 10, in response to a user input, the user terminal 100 may provide various intelligent services to the user. The user input may include, for example, an input through a physical button, a touch input or a voice input.

In an embodiment, the user terminal 100 may provide a voice recognition service through an intelligence app (or a voice recognition app) stored therein. In this case, for example, the user terminal 100 may recognize a user utterance or voice input received through the microphone, and provide a service corresponding to the recognized voice input, to the user.

In an embodiment, the user terminal 100 may perform a designated operation, singly, or together with the intelligence server and/or the service server, on the basis of a received voice input. For example, the user terminal 100 may execute an app corresponding to the received voice input, and perform a designated operation through the executed app.

In an embodiment, in response to the user terminal 100 providing a service together with the intelligence server 200 and/or the service server, the user terminal 100 may sense a user utterance by using the microphone 120, and generate a signal (or voice data) corresponding to the sensed user utterance. The user terminal 100 may transmit the voice data to the intelligence server 200 by using the communication interface 110.

As a response to a voice input received from the user terminal 100, the intelligence server 200 of an embodiment may generate a plan for performing a task corresponding to the voice input, or a result of performing an action according to the plan. The plan may include, for example, a plurality of actions for performing a task corresponding to a user's voice input, and a plurality of concepts related with the plurality of actions. The concept may be a definition of a parameter inputted by execution of the plurality of actions or a result value outputted by the execution of the plurality of actions. The plan may include association information between the plurality of actions and the plurality of concepts.

The user terminal 100 of an embodiment may receive the response by using the communication interface 110. The user terminal 100 may output a voice signal generated by the user terminal 100 to the external by using the speaker 130, or output an image generated by the user terminal 100 to the external by using the display 140.

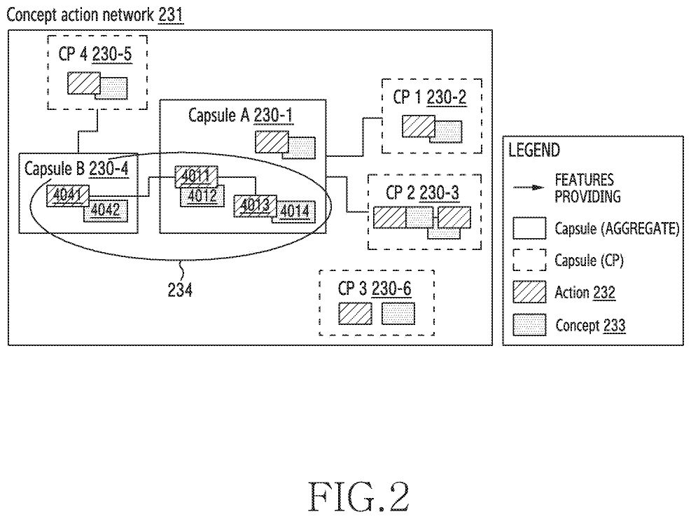

FIG. 2 is a diagram illustrating a form in which relationship information of a concept and an action is stored in a database, according to an embodiment of the disclosure.

Referring to FIG. 2, a capsule database (e.g., the capsule database 230) of the intelligence server 200 may store a capsule in the form of a concept action network (CAN) 231. The capsule database may store an action for processing a task corresponding to a user's voice input and a parameter necessary for the action, in the form of the concept action network (CAN) 231.

The capsule database may store a plurality of capsules (i.e., a capsule A 230-1 and a capsule B 230-4) corresponding to each of a plurality of domains (e.g., applications). According to an embodiment, one capsule (e.g., the capsule A 230-1) may correspond to one domain (e.g., a location (geo) and/or an application). Also, one capsule may correspond to at least one service provider (e.g., a CP 1 230-2 or a CP 2 230-3) for performing a function of a domain related with the capsule. According to an embodiment, one capsule may include at least one or more actions 232 and at least one or more concepts 233, for performing a designated function.

By using a capsule stored in a capsule database, the natural language platform 220 may generate a plan for performing a task corresponding to a received voice input. For example, by using the capsule stored in the capsule database, the planner module 225 of the natural language platform 220 may generate the plan. For example, the planner module 225 may generate a plan 234 by using actions 4011 and 4013 and concepts 4012 and 4014 of a capsule A 230-1 and an action 4041 and concept 4042 of a capsule B 230-4.

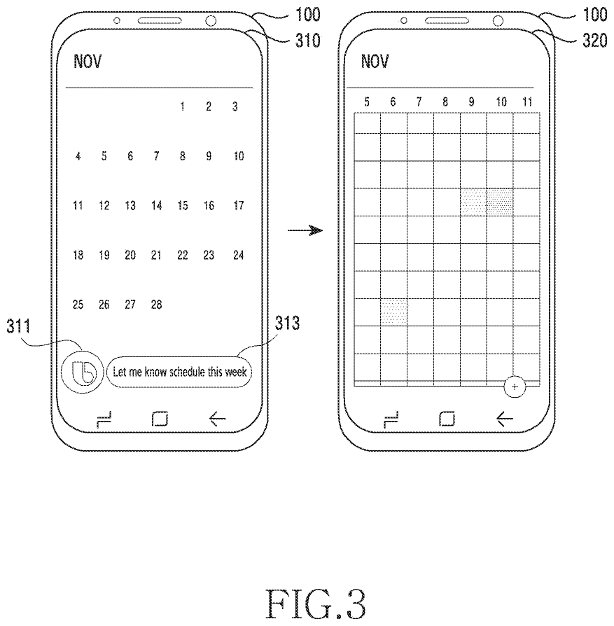

FIG. 3 is a diagram illustrating a screen in which a user terminal processes a received voice input through an intelligence app according to an embodiment of the disclosure.

To process a user input through the intelligence server 200, the user terminal 100 may execute the intelligence app.

According to an embodiment, in screen 310, in response to recognizing a designated voice input (e.g., wake up!) or receiving an input through a hardware key (e.g., a dedicated hardware key), the user terminal 100 may execute the intelligence app for processing the voice input. The user terminal 100 may, for example, execute the intelligence app in a state of executing a schedule app. According to an embodiment, the user terminal 100 may display an object (e.g., an icon) 311 corresponding to the intelligence app on the display 140. According to an embodiment, the user terminal 100 may receive a user input by a user speech. For example, the user terminal 100 may receive a voice input “Let me know a schedule this week!”. According to an embodiment, the user terminal 100 may display a user interface (UI) 313 (e.g., an input window) of the intelligence app in which text data of the received voice input is displayed, on the display.

According to an embodiment, in screen 320, the user terminal 100 may display a result corresponding to the received voice input on the display. For example, the user terminal 100 may receive a plan corresponding to the received user input, and display, on the display, ‘a schedule this week’ according to the plan.

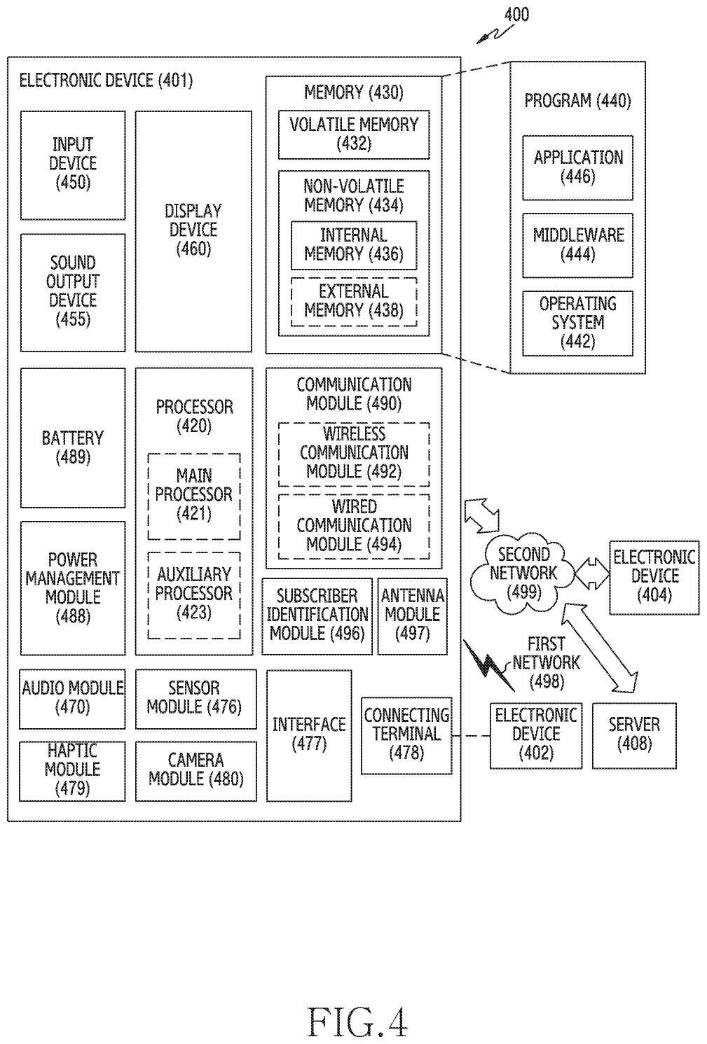

FIG. 4 is a block diagram illustrating an electronic device 401 in a network environment 400 according to an embodiment of the disclosure.

Referring to FIG. 4, the electronic device 401 in the network environment 400 may communicate with an electronic device 402 via a first network 498 (e.g., a short-range wireless communication network), or an electronic device 404 or a server 408 via a second network 499 (e.g., a long-range wireless communication network). According to an embodiment, the electronic device 401 may communicate with the electronic device 404 via the server 408. According to an embodiment, the electronic device 401 may include a processor 420, memory 430, an input device 450, a sound output device 455, a display device 460, an audio module 470, a sensor module 476, an interface 477, a haptic module 479, a camera module 480, a power management module 488, a battery 489, a communication module 490, a subscriber identification module(SIM) 496, or an antenna module 497. In some embodiments, at least one (e.g., the display device 460 or the camera module 480) of the components may be omitted from the electronic device 401, or one or more other components may be added in the electronic device 401. In some embodiments, some of the components may be implemented as single integrated circuitry. For example, the sensor module 476 (e.g., a fingerprint sensor, an iris sensor, or an illuminance sensor) may be implemented as embedded in the display device 460 (e.g., a display).

The processor 420 may execute, for example, software (e.g., a program 440) to control at least one other component (e.g., a hardware or software component) of the electronic device 401 coupled with the processor 420, and may perform various data processing or computation. According to one embodiment, as at least part of the data processing or computation, the processor 420 may load a command or data received from another component (e.g., the sensor module 476 or the communication module 490) in volatile memory 432, process the command or the data stored in the volatile memory 432, and store resulting data in non-volatile memory 434. According to an embodiment, the processor 420 may include a main processor 421 (e.g., a central processing unit (CPU) or an application processor (AP)), and an auxiliary processor 423 (e.g., a graphics processing unit (GPU), an image signal processor (ISP), a sensor hub processor, or a communication processor (CP)) that is operable independently from, or in conjunction with, the main processor 421. Additionally or alternatively, the auxiliary processor 423 may be adapted to consume less power than the main processor 421, or to be specific to a specified function. The auxiliary processor 423 may be implemented as separate from, or as part of the main processor 421.

The auxiliary processor 423 may control at least some of functions or states related to at least one component (e.g., the display device 460, the sensor module 476, or the communication module 490) among the components of the electronic device 401, instead of the main processor 421 while the main processor 421 is in an inactive (e.g., sleep) state, or together with the main processor 421 while the main processor 421 is in an active state (e.g., executing an application). According to an embodiment, the auxiliary processor 423 (e.g., an image signal processor or a communication processor) may be implemented as part of another component (e.g., the camera module 480 or the communication module 490) functionally related to the auxiliary processor 423.

The memory 430 may store various data used by at least one component (e.g., the processor 420 or the sensor module 476) of the electronic device 401. The various data may include, for example, software (e.g., the program 440) and input data or output data for a command related thereto. The memory 430 may include the volatile memory 432 or the non-volatile memory 434.

The program 440 may be stored in the memory 430 as software, and may include, for example, an operating system (OS) 442, middleware 444, or an application 446.

The input device 450 may receive a command or data to be used by other component (e.g., the processor 420) of the electronic device 401, from the outside (e.g., a user) of the electronic device 401. The input device 450 may include, for example, a microphone, a mouse, a keyboard, or a digital pen (e.g., a stylus pen).

The sound output device 455 may output sound signals to the outside of the electronic device 401. The sound output device 455 may include, for example, a speaker or a receiver. The speaker may be used for general purposes, such as playing multimedia or playing record, and the receiver may be used for incoming calls. According to an embodiment, the receiver may be implemented as separate from, or as part of the speaker.

The display device 460 may visually provide information to the outside (e.g., a user) of the electronic device 401. The display device 460 may include, for example, a display, a hologram device, or a projector and control circuitry to control a corresponding one of the display, hologram device, and projector. According to an embodiment, the display device 460 may include touch circuitry adapted to detect a touch, or sensor circuitry (e.g., a pressure sensor) adapted to measure the intensity of force incurred by the touch.

The audio module 470 may convert a sound into an electrical signal and vice versa. According to an embodiment, the audio module 470 may obtain the sound via the input device 450, or output the sound via the sound output device 455 or a headphone of an external electronic device (e.g., an electronic device 402) directly (e.g., wiredly) or wirelessly coupled with the electronic device 401.

The sensor module 476 may detect an operational state (e.g., power or temperature) of the electronic device 401 or an environmental state (e.g., a state of a user) external to the electronic device 401, and then generate an electrical signal or data value corresponding to the detected state. According to an embodiment, the sensor module 476 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 477 may support one or more specified protocols to be used for the electronic device 401 to be coupled with the external electronic device (e.g., the electronic device 402) directly (e.g., wiredly) or wirelessly. According to an embodiment, the interface 477 may include, for example, a high definition multimedia interface (HDMI), a universal serial bus (USB) interface, a secure digital (SD) card interface, or an audio interface.

A connecting terminal 478 may include a connector via which the electronic device 401 may be physically connected with the external electronic device (e.g., the electronic device 402). According to an embodiment, the connecting terminal 478 may include, for example, a HDMI connector, a USB connector, a SD card connector, or an audio connector (e.g., a headphone connector).

The haptic module 479 may convert an electrical signal into a mechanical stimulus (e.g., a vibration or a movement) or electrical stimulus which may be recognized by a user via his tactile sensation or kinesthetic sensation. According to an embodiment, the haptic module 479 may include, for example, a motor, a piezoelectric element, or an electric stimulator.

The camera module 480 may capture a still image or moving images. According to an embodiment, the camera module 480 may include one or more lenses, image sensors, image signal processors, or flashes.

The power management module 488 may manage power supplied to the electronic device 401. According to one embodiment, the power management module 488 may be implemented as at least part of, for example, a power management integrated circuit (PMIC).

The battery 489 may supply power to at least one component of the electronic device 401. According to an embodiment, the battery 489 may include, for example, a primary cell which is not rechargeable, a secondary cell which is rechargeable, or a fuel cell.

The communication module 490 may support establishing a direct (e.g., wired) communication channel or a wireless communication channel between the electronic device 401 and the external electronic device (e.g., the electronic device 402, the electronic device 404, or the server 408) and performing communication via the established communication channel. The communication module 490 may include one or more communication processors that are operable independently from the processor 420 (e.g., the application processor (AP)) and supports a direct (e.g., wired) communication or a wireless communication. According to an embodiment, the communication module 490 may include a wireless communication module 492 (e.g., a cellular communication module, a short-range wireless communication module, or a global navigation satellite system (GNSS) communication module) or a wired communication module 494 (e.g., a local area network (LAN) communication module or a power line communication (PLC) module). A corresponding one of these communication modules may communicate with the external electronic device via the first network 498 (e.g., a short-range communication network, such as Bluetooth™, wireless-fidelity (Wi-Fi) direct, or infrared data association (IrDA)) or the second network 499 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 492 may identify and authenticate the electronic device 401 in a communication network, such as the first network 498 or the second network 499, using subscriber information (e.g., international mobile subscriber identity (IMSI)) stored in the subscriber identification module 496.

The antenna module 497 may transmit or receive a signal or power to or from the outside (e.g., the external electronic device) of the electronic device 401. According to an embodiment, the antenna module 497 may include an antenna including a radiating element composed of a conductive material or a conductive pattern formed in or on a substrate (e.g., PCB). According to an embodiment, the antenna module 497 may include a plurality of antennas. In such a case, at least one antenna appropriate for a communication scheme used in the communication network, such as the first network 498 or the second network 499, may be selected, for example, by the communication module 490 (e.g., the wireless communication module 492) from the plurality of antennas. The signal or the power may then be transmitted or received between the communication module 490 and the external electronic device via the selected at least one antenna. According to an embodiment, another component (e.g., a radio frequency integrated circuit (RFIC)) other than the radiating element may be additionally formed as part of the antenna module 497.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 401 and the external electronic device 404 via the server 408 coupled with the second network 499. Each of the electronic devices 402 and 404 may be a device of a same type as, or a different type, from the electronic device 401. According to an embodiment, all or some of operations to be executed at the electronic device 401 may be executed at one or more of the external electronic devices 402, 404, or 408. For example, if the electronic device 401 should perform a function or a service automatically, or in response to a request from a user or another device, the electronic device 401, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 401. The electronic device 401 may provide the outcome, with or without further processing of the outcome, as at least part of a reply to the request. To that end, a cloud computing, distributed computing, or client-server computing technology may be used, for example.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 440) including one or more instructions that are stored in a storage medium (e.g., internal memory 436 or external memory 438) that is readable by a machine (e.g., the electronic device 401). For example, a processor (e.g., the processor 420) of the machine (e.g., the electronic device 401) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

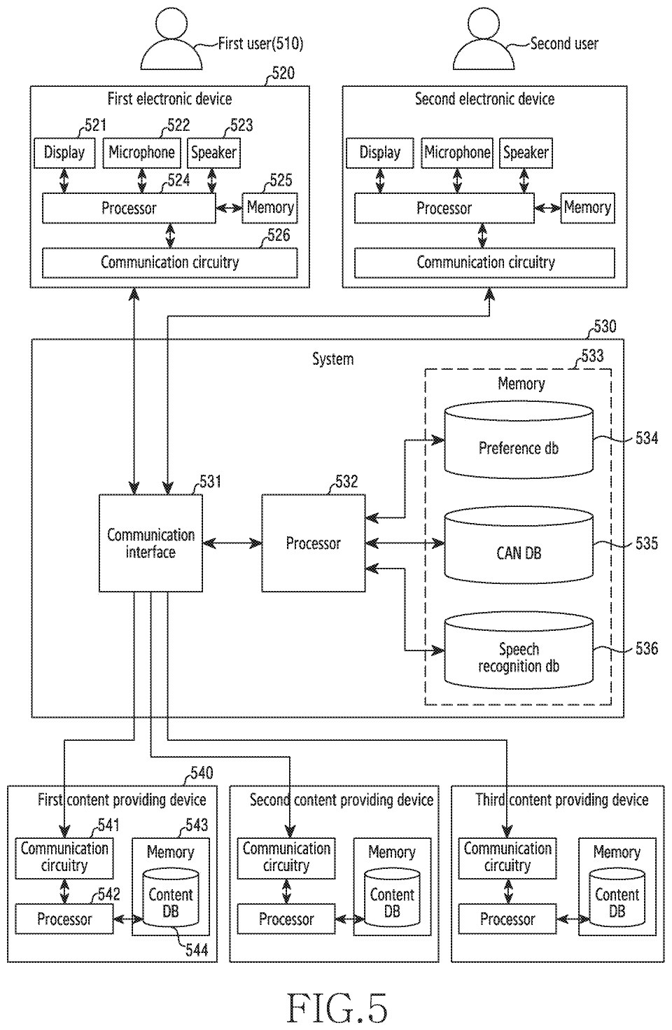

FIG. 5 is a diagram for explaining structures of an electronic device and a system according to an embodiment of the disclosure. In response to a voice signal including a user's utterance, the electronic device and the system according to various embodiments may provide a user with a service related with the utterance. The electronic device and the system may provide a service personalized to each of a plurality of users.

The user may have access to the system by using an electronic device such as a smart phone, a smart pad, a personal digital assistance (PDA), a laptop, and a desktop.

Referring to FIG. 5, a first user 510 and a first electronic device 520 corresponding to the first user 510 are illustrated. The first electronic device 520 may include a display 521 for providing a user interface (UI) to the user, a microphone 522, and a speaker 523. According to some embodiments, a touch panel for reception of a touch input may be arranged on the display 521. The first electronic device 520 may correspond to the user terminal 100 of FIG. 1. The display 521, microphone 522, processor 524, memory 525 and communication circuitry 526 of the first electronic device 520 may each correspond to each of the display 140, microphone 120, processor 160, memory 150 and communication interface 110 of FIG. 1.

The first electronic device 520 may include at least one processor 524. The first electronic device 520 may include the memory 525 storing at least one instruction related with a user interface. The processor 524 may include one or more means (for example, an integrated circuit (IC), very large scale integration (VLSI), an arithmetic logic unit (ALU) or a field programmable gate array (FPGA)) for executing a function corresponding to the instruction. Also, the processor 524 may include a memory (for example, a cache memory) at least temporarily storing data which is obtained by executing the instruction stored in the memory 525 and the function corresponding to the instruction. By executing at least one instruction stored in the memory 525, the processor 524 may generate the user interface, or perform a function related with a user input corresponding to the generated user interface.

By the user interface, interaction between the first user 510 and the first electronic device 520 of various embodiments may occur. The interaction may occur by other input means (for example, a joy stick, a physical button combined to a housing of the first electronic device 520 and/or a virtual reality (VR) device) which may be included in or be coupled to the display 521, the microphone 522, the speaker 523 and the first electronic device 520. In aspects of the first electronic device 520, the interaction may include the output of an image signal through the display 521, the output of a voice signal through the speaker 523, the input of a touch signal by a touch sensor on the display 521, and the input of a voice signal through the microphone 522.

A voice signal inputted through the microphone 522 may include an utterance of the first user 510. The utterance may include one or more words included in a native language of the first user 510. In response to the voice signal including the plurality of words, a sequence of the plurality of words may correspond to a sequence used in a dialog between the first user 510 and another person. The utterance may be an utterance which is based on a natural language of the first user 510.

In response to receiving a voice signal through the microphone 522, the first electronic device 520 may execute a function corresponding to the voice signal. The function may include, in response to a command based on a natural language of the first user 510 included in the voice signal, providing a service of a speech response system to the first user 510. According to some embodiments, the first electronic device 520 may independently execute the function corresponding to the voice signal.

According to various embodiments, the system 530 may be coupled with a plurality of electronic devices including the first electronic device 520, and recognize a user's speech corresponding to each of the plurality of electronic devices. Recognizing the user's speech represents generating a digital electrical signal into which the user's speech included in the voice signal is converted in a form (for example, a text format) which may be analyzed by the first electronic device 520 or system 530. The system 530 may recognize a voice signal obtained from the first user 510, and generate a text signal corresponding to the voice signal. The text signal may be utilized for providing various services related with a speech response system to the first user 510.

Referring to FIG. 5, the first electronic device 520 may be coupled with the system 530 by using a communication machine 526 (for example, a communication module, a communication interface and/or a communication circuitry). The system 530 may correspond to the intelligence server 200 of FIG. 1. The communication machine 526 may include one or more components (for example, a communication chip, an antenna, a local area network (LAN) port and/or an optical port) for connecting to a wireless network (for example, a network being based on at least one of Bluetooth, near field communication (NFC), wireless fidelity (WiFi) and long term evolution (LTE)) or a wired network (for example, a network being based on at least one of Ethernet, a LAN, a wide area network (WAN) and a digital subscriber line (xDSL)). The display 521, microphone 522, speaker 523, processor 524, memory 525 and communication machine 526 included in the first electronic device 520 may be operatively coupled with each other by using a communication bus.

In response to receiving a voice signal through the microphone 522, the first electronic device 520 may transmit the received voice signal to the system 530. For example, the voice signal may be included in one or more packets included in a wireless signal. The wireless signal may be transmitted toward the system 530 through the communication machine 526. The system 530 may include a communication interface 531 for communicating with communication machines included in a plurality of electronic devices such as the communication machine 526.

The system 530 may include at least one processor 532. In response to a voice signal received through the communication interface 531, the processor 532 may execute at least one of a function of identifying a command that is based on a natural language of the first user 510 from the voice signal, a function of executing a service of a speech response system in response to the command, and a function of providing a result of executing the service through the user interface of the first electronic device 520. The system 530 may include a memory 533 storing at least one instruction for executing at least one of the functions. By using the instruction stored in the memory 546, the processor 532 may execute at least one of the functions.

Referring to FIG. 5, at least part of data stored in the memory 533 may be related with a plurality of databases. The processor 532 may manage the data stored in the memory 533 on the basis of the plurality of databases.

To execute the function of identifying the command which is based on the natural language of the first user 510 from the voice signal, the processor 532 of the system 530 may use at least one speech recognition database 536 for recognizing a speech included in the voice signal. A text signal generated corresponding to the voice signal may be related with a natural language (for example, an utterance that the first user 510 inputs toward the microphone 522) included in the voice signal.

The speech recognition database 536 may include a voice signal collected from a plurality of users who use a speech response system, a result (i.e., a text signal) of identifying a natural language included in the voice signal, and information necessary for conversion between the voice signal and the text signal. The speech recognition database 536 may include information related with an acoustic model and a language model, as the information necessary for conversion between the voice signal and the text signal

The acoustic model and the language model refer to a model of recognizing a voice signal on the basis of a Gaussian mixture model (GMM), a deep neural network (DNN) or a bidirectional long short term memory (BLSTM). The acoustic model is used for recognizing the voice signal by the unit of phoneme on the basis of a feature extracted from the voice signal. The speech response system may estimate words that the voice signal represents, on the basis of a result of recognizing, by the unit of phoneme, the voice signal obtained by the acoustic model. The language model is used for obtaining probability information which is based on a coupling relationship between the words. The language model provides probability information about a next word that is to be coupled to a word inputted to the language model. For example, in response to a word “this” being inputted to the language model, the language model may provide probability information in which “is” or “was” is to be coupled subsequent to “this”. According to an embodiment, the speech response system may select a coupling relationship between words whose probability is most high on the basis of the probability information provided by the language model, and output the selection result as a voice recognition result.

The acoustic model and the language model may be configured using a neural network. The neural network refers to a recognition model implemented with software or hardware which imitates a determination capability of a biological speech response system by using a lot of artificial neurons (or nodes). The neural network may perform a human's recognition action or learning process through the artificial neurons. The neural network may include a plurality of layers. For example, the neural network may include an input layer, one or more hidden layers and an output layer. The input layer may receive input data for training of the neural network and forward the received input data to the hidden layer, and the output layer may generate output data of the neural network on the basis of signals received from nodes of the hidden layer.

The one or more hidden layers may be located between the input layer and the output layer, and may be converted into a value easy to predict input data forwarded through the input layer. Nodes included in the input layer and the one or more hidden layers may be coupled with each other through a coupling line having a coupling weight, and nodes included in the hidden layer and the output layer may be also coupled with each other through a coupling line having a coupling weight.

The input layer, the one or more hidden layers and the output layer may include a plurality of nodes. The hidden layer may be a convolution filter in a convolutional neural network (CNN) or be a fully connected layer, or may be various kinds of filters or layers that are bound with a criterion of a special function or feature. A recurrent neural network (RNN) in which an output value of the hidden layer is inputted again to a hidden layer of a present time may be used for the acoustic model and the language model.

Among neural networks, a neural network including a plurality of hidden layers is called a deep neural network. Learning the deep neural network is called deep learning. Among nodes of the neural network, a node included in a hidden layer is called a hidden node. The speech recognition database 536 may include information (for example, the coupling weight, and/or an attribute of a node included in the neural network) related with the acoustic model, the language model, and the neural network related with each model.

In response to receiving the voice signal obtained from the first user 510 through the communication interface 531, the processor 532 may generate a text signal corresponding to the received voice signal, on the basis of the acoustic model and language model generated from the speech recognition database 536. The text signal may include a plurality of words included in an utterance of the first user 510. On the basis of the kind or sequence of the plurality of words included in the text signal, the processor 532 may identify a command which is based on a natural language of the first user 510 included in the voice signal.

To execute a service of the speech response system corresponding to the identified command, the processor 532 of the system 530 may use a CAN database 535 related with a concept action network (CAN). The processor 532 may identify a concept and action corresponding to the command by using the CAN database 535. An operation of coupling the identified concept and action may be performed on the basis of an operation related with the concept action network 231 of FIG. 2.

In response to the plan being generated by coupling the concept and the action corresponding to the command, the processor 532 may perform an action which is based on a plan generated using the execution engine 240 of FIG. 1. The action may include an action of outputting a recognized text message to the first user 510 through the first electronic device 520. The action may be an action of controlling a parameter (for example, a volume of the speaker 523, a brightness of the display 521, and/or locking or unlocking of the first electronic device 520) of the first electronic device 520. The action may be an action of executing an application (for example, a photo application, a weather application, and/or other third-party applications) stored in the first electronic device 520. The action may be an action of providing content to the first user 510.

The system 530 may be coupled with one or more content providing devices managed by a subject providing content, through a wireless network or a wired network. Referring to FIG. 5, a first content providing device 540 to a third content providing device which are coupled with the system 530 are shown. The first content providing device 540 may receive a request related with provision of content from the system 530 through a communication machine 541.

For example, in response to the first user 510 inputting an utterance including a command of requesting content related with the first content providing device 540 to the microphone 522, the system 530 may recognize a voice signal received from the first electronic device 520, to identify the command. In response to the identified command, the system 530 may couple the concept and the action, to generate a plan corresponding to the command. While executing the generated plan, the system 530 may request provision of content to the first content providing device 540.

The content providing device may include a processor coupled with a communication machine and executing a function corresponding to a request received from a system. Referring to FIG. 5, in response to receiving a request through the communication machine 541, a processor 542 of the first content providing device 540 may identify data to be provided to a user, among data stored in the first content providing device 540. The first content providing device 540 may include a memory 543 for storing an instruction related with a search of content, and a content database 544 for managing the content. The processor 542 may transmit content including the identified data from the content database 544 to the system 530.

Content provided by the content providing device may include a result of, in response to an identified command from a user, searching or selecting an item among a plurality of items. The item, which is data provided to the user, may be data corresponding to a target that the user intends to obtain from a content provider. The item may correspond to a row or instance of a database. For example, in response to the user using a hotel reservation service, the item may correspond to a hotel. For another example, in response to the user using an internet shopping service, the item may correspond to a product. For example, in response to the first content providing device 540 providing content related with a restaurant, the content database 544 may store a plurality of items corresponding to each of a plurality of restaurants.

The item may include one or more objects. The object may correspond to a field or column of a database. For example, in response to the user using a hotel reservation service, the item may include objects such as a hotel location and a hotel phone number. For another example, in response to the user using an internet shopping service, the item may include objects such as a product price and/or a product seller. In response to the first content providing device 540 providing content related with a restaurant, the item may include objects such as a location of a restaurant, the kind of the restaurant (Korean restaurant, Western restaurant and/or Chinese restaurant), a menu of the restaurant, and/or user's evaluation of the restaurant.

The object may be a criterion of identifying a sequence of items in content provided to the system 530. In response to a command of the first user 510 identified from a voice signal being a command related with the first content providing device 540 (for example, “Please search a nearby restaurant”), the system 530 may transmit, to the first content providing device 540, a request for providing a result of searching a nearby restaurant to the first user 510. In this case, content received by the system 530 may include a plurality of items corresponding to each of restaurants adjacent to the first user 510. A sequence of the plurality of items included in the content may be related with an object (i.e., a location of a restaurant) included in the command. For example, an item corresponding to a restaurant located closest to the first user 510 may be arranged at the highest level of the content.

In response to the execution of the service of the speech response system corresponding to the identified command, the processor 532 may provide a result of executing the service or a process of executing the service, through a user interface of the first electronic device 520. The processor 532 may transmit the result of executing the service or the process of executing the service to the first electronic device 520. For example, the processor 532 may transmit content received from the first content providing device 540, to the first electronic device 520. The first electronic device 520 may output the received content on the display 521 according to a layout of the user interface.

A result provided by at least one of a plurality of content providing devices is difficult to satisfy all users, so a user may input a user's intention, preference or purpose to the electronic device or the system 530, so as to obtain one or more items desired by the user himself. On the basis of the inputted user's intention, preference or purpose, the system 530 may send a request for searching, selecting or sorting an item, to at least one of a plurality of content providing device. A preference may be expressed with the user's intention, preference or purpose. Below, an operation related with embodiments is explained on the basis of the preference, but various embodiments are not limited to this.

In response to a command related with a search of an item inputted from a user, the system 530 may send a request for searching, selecting or sorting items by using the preference, to at least one of the plurality of content providing devices. The preference is data personalized to the user. The preference may be related with a criterion in which at least one of a plurality of items is selected by the user. By using the preference database 534, the processor 532 of the system 530 may manage the preference.

The preference may be related with an object which the user is relatively more concerned with in response to the user selecting at least one of a plurality of items. Among a plurality of objects included in the item, the object which the user is more concerned with is called a preference object. The plurality of items provided to the user may be sorted on the basis of the preference object. The user may more easily identify an item preferred by the user himself from the sorted plurality of items.

In response to a command of the first user 510 identified from a voice signal being a command related with the first content providing device 540 (for example, “Please search a nearby restaurant”), the system 530 may identify a location of a restaurant as a preference object. The preference object may be used for sorting the plurality of items which are identified corresponding to the command. The preference object may be used for sorting a plurality of items which are searched corresponding to another command inputted from the first user 510 after the command.

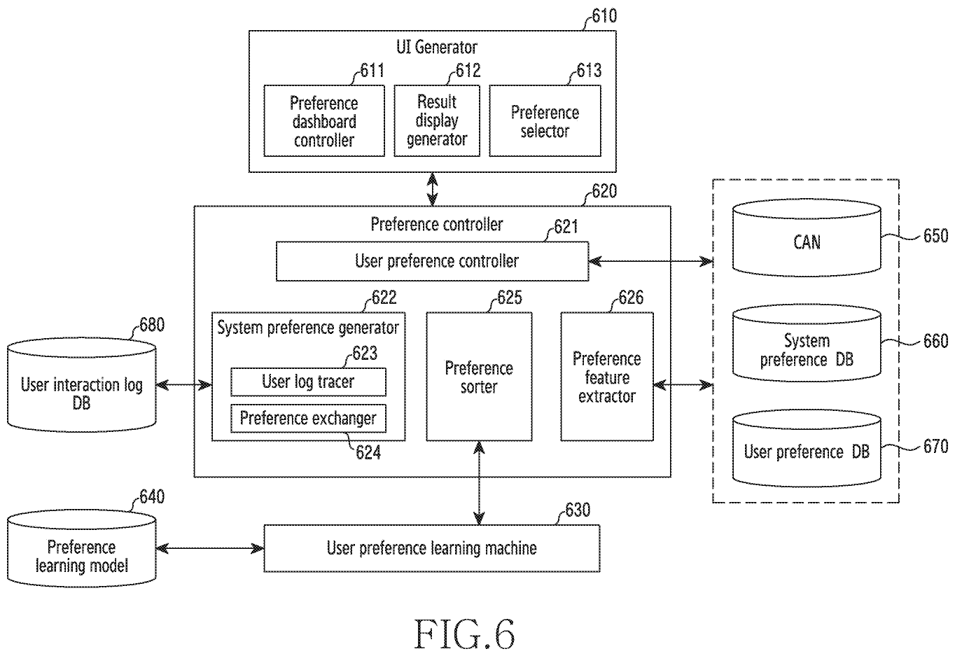

FIG. 6 is a diagram conceptually illustrating a hardware component or software component that a system uses to manage a preference according to an embodiment of the disclosure. Below, referring to FIG. 6, an operation in which the system provides content to the user is explained. The hardware component or software component illustrated in FIG. 6 may correspond to the processor 524 of the plurality of electronic devices (for example, the first electronic device 520) of FIG. 5 and the processor 532 of the system 530, or correspond to at least one of an application executed by at least one of the processors 524 and 530, a thread and a process.

Referring to FIG. 6, a UI generator 610 may generate a user interface (UI) and, in response to a user's input related with the generated user interface, change the user interface. For example, by executing an instruction related with the UI generator 610, the processor 524 of the first electronic device 520 of FIG. 5 may change the user interface in response to an input of the first user 510.

The UI generator 610 may include at least one of a preference dashboard controller 611, a result display generator 612, and a preference selector 613.

The preference selector 613 may add an interface to initiate a function for changing a preference, on a user interface provided to a user. In order for the user to add or change the preference, the preference selector 613 may change an operation mode of the user interface. The operation mode may include a preference adjusting mode related with a state of adding or changing the preference, and an item display mode related with a state of displaying an item on the user interface on the basis of the preference. An operation of changing the operation mode of the interface related with the preference selector 613 and the speech response system is described later.

In response to the operation mode being changed into the preference adjusting mode, the preference dashboard controller 611 may generate a user interface for outputting information (for example, a preference object) related with a preference personalized to a user. The user interface generated by the preference dashboard controller 611 may receive an input for change of the preference from the user. In response to receiving the input for change of the preference from the user, the preference dashboard controller 611 may change the information (for example, the preference object) related with the preference.

The information related with the preference outputted to the user may be generated by the user, or be generated on the basis of a traced user's activity. Below, a preference generated by user's inputting of one or more preference objects is called a user preference. Below, a preference generated by the electronic device or system on the basis of the user's traced activity is called a system preference.

The preference dashboard controller 611 may display which preference has been applied to a layout provided to a user, on a user interface. For example, the preference dashboard controller 611 may emphasize a preference object among a plurality of objects outputted on the user interface. Or, the preference dashboard controller 611 may output a list of preference objects to a designated region of the user interface.

The result display generator 612 may adjust a layout of a display on the basis of a preference object identified by the preference dashboard controller 611. The result display generator 612 may generate a user interface which includes a result of arranging an item and an object included in the item according to the adjusted layout.

The preference controller 620 may be coupled with a concept action network (CAN) 650. The CAN 650 may be related with the CAN database 535 of FIG. 5. The preference controller 620 may manage objects related with a user's preference. The preference controller 620 may control to store data in a database related with the user's preference (a speech response system preference database 660, a user preference database 670 and a user interaction log database 680 in an example of FIG. 6), or refine the database. The preference controller 620 may analyze a user log, or perform learning which uses a user log.

The preference controller 620 may include a user preference controller 621. The user preference controller 621 may perform a function related with a user preference generated by directly inputting preferences of objects from a user. The function performed by the user preference controller 621 may include at least one of a function of adding a user preference to the user preference database 670 and a function of deleting a user preference stored in the user preference database 670. The user preference controller 621 may be coupled with the CAN 650, and identify objects that are within a capsule structure. The user preference controller 621 may represent that the at least one of the plurality of objects corresponds to a preference object by adding a tag to at least one of a plurality of objects.

For example, in response to the user selecting a specific object in the preference adjusting mode, the user preference controller 621 may display the specific object as a preference object by using a tag or flag related with the selected specific object. In response to the selecting of the specific object, the user preference controller 621 may identify a plurality of attributes of the specific object.

The preference controller 620 may include a preference feature extractor 626. The preference feature extractor 626 may identify a feature of an attribute of an object. In response to the user preference controller 621 identifying a plurality of attributes of the specific object correspondingly to the selecting of the specific object, the preference feature extractor 626 may identify a feature of the identified attribute. The feature may be related with an attribute of an object the user prefers.

For example, in response to a user selecting a rating, the preference feature extractor 626 may identify a feature of a rating preferred by the user (for example, whether the user desires to match with the selected rating, or which range the user prefers among the rating or more or less). For example, in response to the user selecting an image, the preference feature extractor 626 may identify a feature of the image preferred by the user among an atmosphere of the image, a thing included in the image, and a color of the image.

The preference feature extractor 626 may request a user to select which feature the user prefers among the identified plurality of features. A result of user's selecting the feature may be included in a user preference by the user preference controller 621. Also, the result may be stored in the user preference database 670.

The preference controller 620 may include a system preference generator 622 for generating a system preference. The system preference generator 622 may include a user log tracer 623 and a preference exchanger 624.

The user log tracer 623 may identify a preference object among a plurality of objects, by using log data indicating a user's activity related with a user interface (for example, an operation in which a user selects an item provided through the user interface). The user log tracer 623 may identify the log data from the user interaction log database 680. In response to the user interface, the user interaction log database 680 may store a signal that the user inputs to an electronic device, in time order. According to some embodiments, the user log tracer 623 may request the user to select a preference object among preference object candidates.

A preference object that the user log tracer 623 identifies may be stored in the user preference database 670. The preference object stored in the user preference database 670 may be managed by the user preference controller 621.

The preference exchanger 624 may control a preference object wherein the preference object identified using a specific content providing device is used for sorting items provided by another content providing device. For example, by using an object capsule or inheritance relationship, the preference exchanger 624 may change a preference object corresponding to a specific content providing device wherein the changed preference object may be utilized for an operation related with another content providing device. The changed preference object may be used when another content providing device searches an item. In response to the user using another content providing device, the changed preference object may be provided to the user.

The preference controller 620 may include a preference sorter 625. In response to a plurality of preferences being stored in the system preference database 660 and the user preference database 670, the preference sorter 625 may identify order of priority of the plurality of preferences. The identified order of priority of the preferences may be used for searching of an item by a content providing device. The identified order of priority of the preferences may be used for identifying a layout of an item that will be provided to the user.

The preference sorter 625 may identify the order of priority of the preferences, by using a score corresponding to each preference. To identify the score corresponding to each preference, the preference sorter 625 may use a user preference learning machine 630. The user preference learning machine 630 may identify a user's activity related with a preference object on a user interface, from log data stored in the user interaction log database 680.

On the basis of the user's activity related with the identified preference object, the user preference learning machine 630 may learn to identify order of priority of a preference object. The user preference learning machine 630 may use a preference learning model 640 related with learning of the order of priority of the preference object. The preference learning model 640 may correspond to a neural network supporting deep learning. The user preference learning model 640 may be personalized corresponding to each of a plurality of users by the user preference learning machine 630.

The user preference learning model 640 may be used for classification or extension of a preference object. For example, the preference sorter 625 may combine the preference object and other information, on the basis of the user preference learning model 640. The other information combined to the preference object may include context information related with a user's activity (for example, time information, place information, electronic device information corresponding to an electronic device the user makes use of, financial information, biometric information, motion information, and/or purchase information). The preference object combined with the other information may be used for the learning of the user preference learning module 640, and be used when the user preference learning model 640 is personalized corresponding to each of a plurality of users.

Capsules implemented by a capsule developer may be stored in the CAN 650. The capsule developer may correspond to a manager of a system (for example, the system 530 of FIG. 5) or a manager of a content providing device. The capsule developer may store, in the CAN 650, a candidate being usable as a preference object.

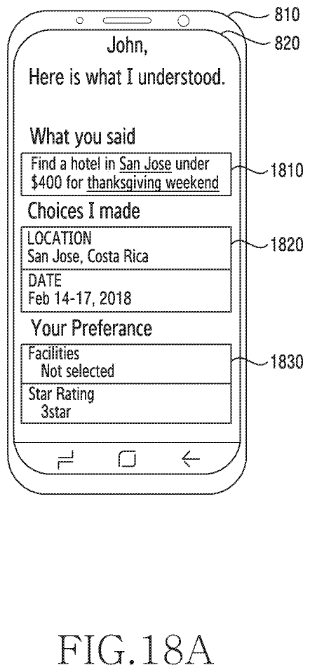

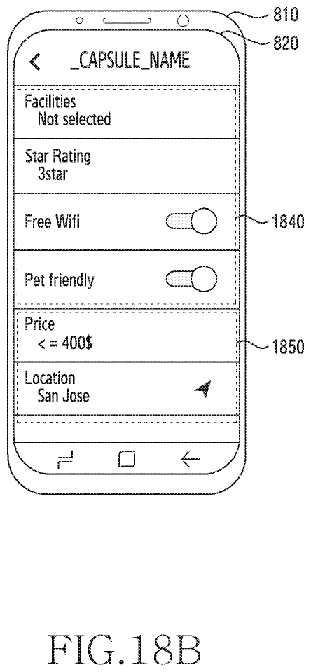

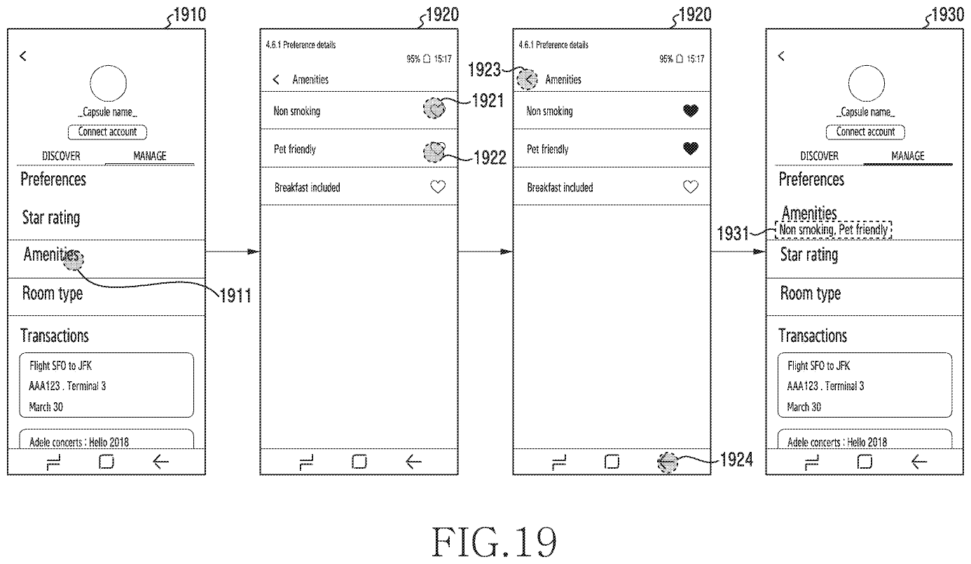

The preference feature extractor 626 may provide a preference object frequently used by a user to the user, on the basis of a user's record of use (for example, a user interaction log included in the user interaction log database 680). The preference object provided to the user by the preference feature extractor 626 may be outputted in a UI (for example, a preference dashboard) of an electronic device (for example, FIGS. 18A to 18B and FIG. 19).

A preference object enabled or disabled by a user may be stored in the user preference database 670 by the system. In response to the preference object enabled by the user being plural, the preference sorter 625 may identify order of priority of each of preference objects. A model generated through learning may be stored in the preference learning model 640. When the electronic device outputs a UI in response to a user's speech, a list of items applying a preference object according to order of priority may be outputted in the UI.

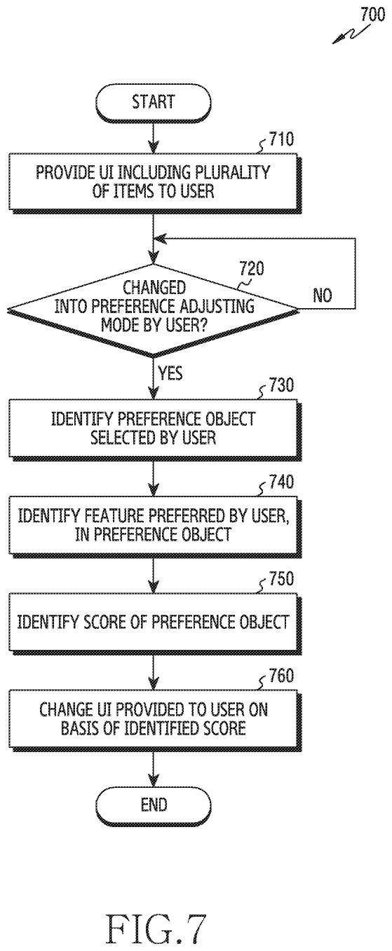

FIG. 7 is a flowchart 700 for explaining an operation in which an electronic device or a system sorts a plurality of items provided to a user, by using a preference object according to an embodiment of the disclosure.

At operation 710, the electronic device of various embodiments may provide a user interface including the plurality of items to the user. The user interface may be generated corresponding to a voice signal including a user's utterance. In some embodiments, the electronic device may receive the user's utterance through a microphone. In response to reception of the user's utterance, at operation 710, the electronic device may provide the user interface including the plurality of items to the user. The user may input the voice signal to the electronic device included in a speech response system.

For example, referring to FIG. 5, the first user 510 may input a voice signal to the microphone 522 of the first electronic device 520. The voice signal inputted to the first electronic device 520 may be recognized by the system 530 coupled with the first electronic device 520.

In response to the recognized voice signal, the system may request provision of content to at least one of a plurality of content providing devices coupled with the system. In response to the request, the at least one content providing device may transmit content including a plurality of items to the system. From the received content or the plurality of items included in the content, the system may generate information about the user interface that will be provided to the user through the electronic device. The system may transmit the generated information to the electronic device. The electronic device may output the user interface corresponding to the received information, to the user.

The user may control a user interface outputted from the electronic device, to perform an operation related with a plurality of items. The user interface may include a list of the plurality of items arranged in a designated sequence. The user may identify the plurality of items by scrolling the list, and may select at least one of the plurality of items from the list. The user interface may include at least one of an interface (for example, a ‘delete’ button) of removing a selected item from the list, an interface (for example, a ‘like’ button) of classifying by a separate list (for example, a list related with an item of concern), and an interface (for example, a ‘search’ button) for outputting more detailed information related with a selected item. In response to performing an operation (for example, a gesture of touching a search button) in which the user selects the interface, the electronic device or the system may execute a function related with the selected interface.

The user interface may include not only the illustrative interfaces but also an interface (for example, a preference selection mode button) for controlling a preference related with an object included in an item. The interface may switch the operation mode of the user interface. The operation mode switched through the interface may include a preference adjusting mode related with addition, change and deletion of a preference, and an item display mode of changing a sequence or layout of a plurality of items in the user interface on the basis of the preference.

At operation 720, the electronic device may identify whether the operation mode of the user interface has been converted into the preference adjusting mode by a user. The user selects an interface for controlling a preference included in the user interface and, in response to the operation mode not being the preference adjusting mode, the electronic device may convert the operation mode into the preference adjusting mode. In response to converting into the preference adjusting mode, the electronic device may provide an interface of enabling the user to select an object related with a plurality of items, to the user.

According to various embodiments, an operation that the electronic device performs in response to selection of an object in the user interface may be different depending on whether the operation mode is the preference adjusting mode. In response to the operation mode not being the preference adjusting mode, the electronic device may perform, in response to the selection of the object by the user, an operation related with an item corresponding to the selected object (for example, an operation of outputting detailed information of the item). In response to the operation mode being the preference adjusting mode, the electronic device may perform, in response to the selection of the object by the user, an operation of identifying the selected object as a preference object.

At operation 730, in response to the selection of the object by the user in the preference adjusting mode, the electronic device may identify the preference object selected by the user. As described above, the electronic device may identify, as the preference object, the object selected by the user in the user interface. A result in which the electronic device identifies the preference object may be transmitted to the system. The system may store the result in at least one of a user interaction log database (for example, the user interaction log database 680 of FIG. 6) and a user preference database (For example, the user preference database 670 of FIG. 6).

At operation 740, in response to identifying the preference object selected by the user, the system may identify a feature preferred by the user, in the identified preference object. The system may identify an attribute preferred by the user, among attributes of the object. For example, in response to the object selected by the user being a score of an item made by the public, the attribute of the object may be a value (for example, 4.5) corresponding to the object selected by the user. In the above example, the system may identify that the user prefers the item having the score of 4.5 from the identified attribute of the object. In the example, a feature identified by the system is a value of the object. In accordance with the kind of the object, the feature may be a type and/or a character. In response to identifying the feature preferred by the user, the system may combine a tag related with the identified feature to the preference object.

At operation 750, the system may identify a score of the preference object selected by the user. In response to a plurality of preference objects related with a plurality of items existing, the score may be used for identifying order of priority of the plurality of preference objects. In response to identifying of the preference object identified at operation 730 and a preference object previously stored in the system, the system may identify a correlation or an importance between the identified plurality of preference objects. Identifying the correlation or importance between the identified plurality of preference objects may be performed by a preference sorter of the system (for example, the preference sorter 625 of FIG. 6).

According to some embodiments, when identifying the correlation or importance between the identified plurality of preference objects, the system may use a designated rule. For example, the system may assign the highest score to a preference object most recently designated by the user, and assign the lowest score to a preference object most previously designated by the user, on the basis of a rule related with a time order identified through the preference object. The system may assign a relatively high score to a preference object frequently used for sorting of a plurality of items, and assign a relatively low score to a preference object not relatively frequently used for sorting of the plurality of items, on the basis of a rule related with a frequency in which the preference object is used.

In response to a plurality of scores being assigned to one preference object on the basis of a plurality of rules, a weight corresponding to each of the plurality of rules may be applied to the plurality of scores, and a combination of the plurality of scores to which the weight is applied may be identified as a final score of the preference object. The system may associate a sequence of a final score of each of a plurality of preference objects and order of priority of the plurality of preference objects.

According to some embodiments, when identifying a correlation or importance between the identified plurality of preference objects, the system may use a neural network or deep learning. For example, referring to FIG. 6, the user preference learning machine 630 and the preference learning model 640 may be related with the neural network or deep learning. In response to identifying of the preference object selected by the user, the system may learn a correlation between the identified preference object and the existing selected preference object, from user interaction log data related with the identified preference object.

For example, in response to a user selecting a first object as a preference object, the system may learn how the selected first object and the existing stored preference objects have been used. By using not only user interaction log data but also context information, place information, device information and/or financial information, the system may extend information related with a preference. The extended information related with the preference may be related with deep learning based training and/or classification information, and may be used for generation of a personalized model corresponding to the user.

at operation 760, the electronic device or the system may change a user interface provided to the user, on the basis of the identified score. The system may identify a sequence of a plurality of items in the user interface, and/or a layout of one or more objects related with each of the plurality of items on the user interface, on the basis of the identified score. Information related with the identified sequence of the plurality of items and the layout may be transmitted to the electronic device.

In accordance with the received information, the electronic device may change the sequence of the plurality of items in the user interface, or change a location of an object. The sequence of the plurality of items may be identified on the basis of the identified preference object and the identified feature. The location of the object may be changed on the basis of a score of each of the preference object selected by the user and the plurality of preference objects.

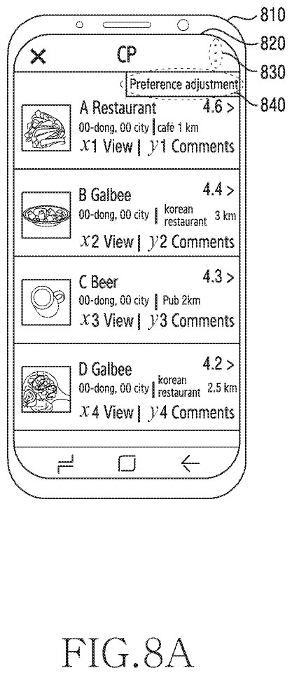

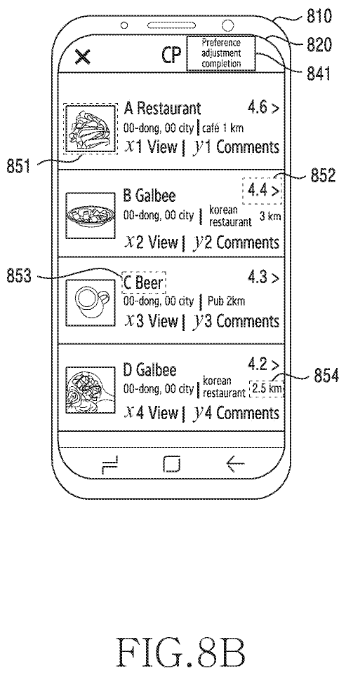

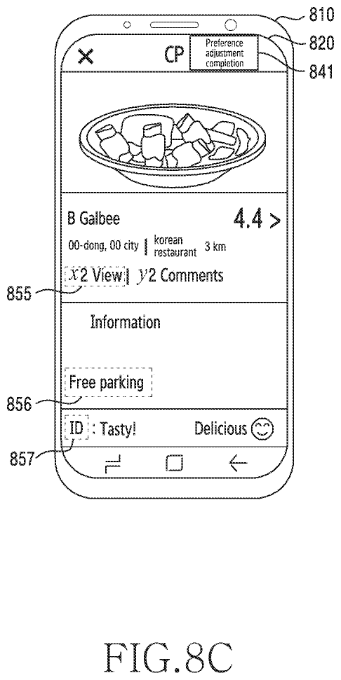

FIGS. 8A to 8C are example diagrams for explaining a user interface that an electronic device provides to a user according to various embodiments.

Referring to FIGS. 8A to 8C, the user interface may be provided to the user through an electronic device 810 included in a speech response system. The electronic device 810 may correspond to the first electronic device 520 of FIG. 5. The user interface may include one or more items which are searched in response to a voice signal inputted from the user and an utterance included in the voice signal. In FIGS. 8A to 8C, it is assumed that the speech response system searches a plurality of restaurants in response to an utterance (for example, “Hey Bixby, let me know a nearby restaurant”) related with restaurant search inputted from the user. In the assumption, the plurality of items provided to the user may correspond to the searched plurality of restaurants, respectively.

FIG. 8A is a diagram illustrating an example of outputting a result of searching a plurality of restaurants through the electronic device 810 according to an embodiment of the disclosure.

Referring to FIG. 8A, a name of a content provider used for searching the plurality of restaurants may be displayed in at least a portion of a user interface outputted on a display 820 of the electronic device 810. The plurality of restaurants may be displayed in at least a portion (for example, a portion other than the portion where the name of the content provider is displayed) of the user interface on the basis of a first sequence.

An object related with each of the plurality of restaurants may be displayed in at least a portion of the user interface. Referring to FIG. 8A, objects related with each of the plurality of restaurants may be, on the user interface, displayed as a name of the restaurant, an image related with the restaurant, a score of the restaurant, an address of the restaurant, the kind of the restaurant (café, Korean restaurant, pub, Japanese restaurant, Chinese restaurant and/or Western restaurant), a distance between a user and the restaurant determined from the address of the restaurant, the number of views of the restaurant and the number of reviews on the restaurant. The objects may be arranged on the user interface on the basis of the first sequence or a layout of the objects in the item (restaurant). In each of the plurality of items, the layouts of the objects may coincide with each other.

Referring to FIG. 8A, an arrangement of objects corresponding to an A restaurant and an arrangement of objects corresponding to a B Galbee may coincide with each other.

By performing a gesture in at least a portion of the user interface in which the plurality of restaurants are displayed, the user may select some of the plurality of restaurants, or identify the plurality of restaurants according to the first sequence. An operation in which the electronic device 810 or the system performs in response to the gesture may be different depending on a current operation mode of the user interface. The operation mode may include an item display mode and a preference adjusting mode. In response to the gesture on the user interface performed by the user, the electronic device 810 may perform any one of a plurality of actions according to the current operation mode among a plurality of operation modes of the user interface.

In response to the current operation mode being the item display mode that is a mode of displaying an item according to a preset preference, in response to a selection of an object by a user on the user interface, the electronic device 810 may output detailed information of an item related with the selected object. In an example of FIG. 8A, in response to the user touching a restaurant name (object) of the A restaurant in the item display mode, the electronic device 810 may output detailed information of the A restaurant on the user interface. The detailed information of the A restaurant may include not only an object outputted in FIG. 8A but also all objects related with the A restaurant stored in a content provider.

In response to the current operation mode being the preference adjusting mode that is a mode for controlling a preference, in response to a selection of an object by the user on the user interface, the electronic device 810 may perform addition, deletion, or change of a preference object on the basis of the selected object. Conversion between the item display mode and the preference adjusting mode may be performed by an interface related with conversion of an operation mode included in at least a portion of the user interface.

For example, the user may touch a menu button 830 on the display 820, and may touch a sub menu 840 which is outputted on the display 820 in response to the touching of the menu button 830, to change an operation mode. In response to the touching of the sub menu 840, the electronic device 820 may toggle the operation mode between the item display mode and the preference adjusting mode. According to some embodiments, besides the menu button 830 or the sub menu 840, the user may input a voice signal including an utterance related with preference adjustment to the electronic device 810, or press a button exposed to the external through a housing of the electronic device 810, to change the operation mode.

FIG. 8B is a diagram illustrating an example of a user interface in which the operation mode is changed into the preference adjusting mode according to a user's command according to an embodiment of the disclosure. In response to the current operation mode being the preference adjusting mode, in response to a selection of an object by a user on the user interface, the electronic device 810 may identify the selected object as a preference object. The preference object may include information related with an attribute or feature of the selected object. The information related with the attribute or feature of the selected object may be identified by user's selection or user's analysis of log data (for example, tracing of the log data by the user log tracer 623 of FIG. 6).

Referring to FIG. 8B, in response to the user touching an image object 851 related with the A restaurant, the electronic device 810 or the system may identify a preference object on the basis of the touched image object 851. The preference object may include information related with a feature of the image object 851. A description is made later for an operation in which the electronic device 810 or the system according to various embodiments identifies a feature of the image object 851.

In response to the user touching a score object 852 related with the B Galbee, the electronic device 810 or the system may identify the score object 852 as a preference object. The preference object may include information related with a value (4.4.) of the score object 852 selected by the user.

In response to the user touching a name object 853 of a C Beer, the electronic device 810 or the system may identify the name object 853 as a preference object. The preference object may include information related with a character string (C Beer) of the name object 853 touched by the user.

In response to the user touching a distance object 854 of a D Galbee, the electronic device 810 or the system may identify the distance object 854 as a preference object. The preference object may include information related with a value (2.5 km) of the distance object 854.

In the preference adjusting mode, the user interface may include an interface to escape from the preference adjusting mode. For example, a user may touch a preference adjusting completion button 841, to adjust the operation mode from the preference adjusting mode to other mode (for example, the item display mode). In response to transition of the operation mode from the preference adjusting mode to other mode, a first sequence of arranging a plurality of items on the user interface may be changed into a second sequence distinguished from the first sequence. The second sequence may be identified on the basis of a preference object designated by the user.

In response to the image object 851 being identified as the preference object, the electronic device 810 or the system compare a feature of an image object included in each of a plurality of items and a feature of the image object 851 touched by the user, to identify the second sequence.

In response to the score object 852 being identified as the preference object, the electronic device 810 or the system may compare a value of a score object included in each of the plurality of items with a value (4.4) of the score object 852. The second sequence may be identified on the basis of a result of comparing the value of the score object included in each of the plurality of items with the value (4.4) of the score object 852.

In response to the name object 853 being identified as the preference object, the second sequence may be changed on the basis of a similarity with a character string (C Beer) of the name object 853 or inclusion or non-inclusion of the character string (C Beer).

In response to the distance object 854 being identified as the preference object, the second sequence may be changed according to whether a value of a distance object included in each of the plurality of items is included in a section related with a value (2.5 km) of the distance object 854.

If there exists a preset preference object which is generated before entering the preference adjusting mode, the electronic device 810 may emphasize an object corresponding to the preset preference object. For example, in response to the preset preference object corresponding to a score object having a value of 4.4, the electronic device 810 may emphasize a score object 852 corresponding to the preset preference object, among a plurality of score objects displayed on the user interface. Emphasizing the score object 852 may include at least one of changing of a color of a text or image included in the score object 852, appending of a figure or image related with the score object 852, and applying of an animation such as flickering of the score object 852.

That the user selects the preference object may be, as illustrated in FIG. 8B, performed on a list of a plurality of items as well, and may be performed even on the user interface outputting detailed information of any one of the plurality of items. For example, in the item display mode, in response to the user selecting any one (B Galbee) of the plurality of items illustrated in FIG. 8A, the electronic device 810 may output detailed information related with the selected item (i.e., all objects related with the B Galbee). While the detailed information related with the selected item is outputted, the user may touch the sub menu 840, to change the operation mode into the preference adjusting mode.

FIG. 8C is an example diagram for explaining an operation in which a preference object is selected from a user interface that outputs detailed information of any one (B Galbee) of the plurality of items illustrated in FIG. 8A according to an embodiment of the disclosure.

Referring to FIG. 8C, in response to a user selecting any one (B Galbee) of the plurality of items, the electronic device 810 may, instead of outputting a list that is based on a first sequence of the plurality of items, output all objects related with an item selected by the user. For example, an interface including all the objects related with the item selected by the user may hide at least a portion of the list that is based on the first sequence of the plurality of items.

Referring to FIG. 8C, in the preference adjusting mode, at least one of all objects related with an item selected by a user may be selected by the user. The electronic device 810 may identify at least one object selected by the user, as a preference object. Referring to FIG. 8C, the objects related with the item selected by the user may be outputted as a view object 855, a parking information object 856 and/or a reviewer ID object 857. The electronic device may identify at least one of objects which are outputted in response to user's selection, as a preference object.

In response to an object identified as a preference object being an object not outputted on a list of a plurality of items, the electronic device may change a user interface or a layout wherein the object identified as the preference object is outputted on the list of the plurality of items. For example, referring to FIGS. 8B to 8C, the parking information object 856 and the reviewer ID object 857 are objects not outputted on the list of the plurality of items. In response to the user selecting any one of the parking information object 856 and the reviewer ID object 857, the electronic device 810 may identify the selected object as a preference object, and change a layout of the list of the plurality of items wherein the identified preference object is outputted on the list of the plurality of items.

In the preference adjusting mode, in response to the object selected by the user including a plurality of attributes or features, the electronic device 810 or the system may request the user to select at least one of the plurality of attributes or features. The electronic device 810 or the system may add an interface for user's selection on the user interface, on the basis of an attribute (type, value, character string, GPS coordinate and/or image) and feature (type, value, character string, GPS coordinate and/or image) of the object.

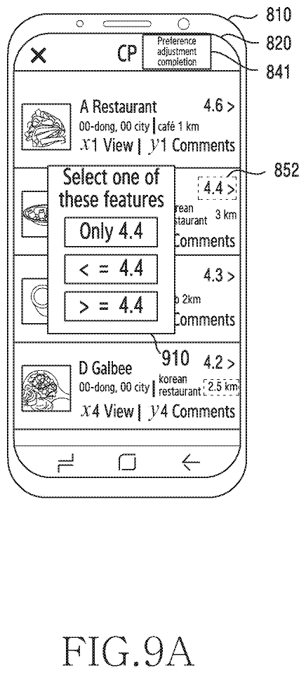

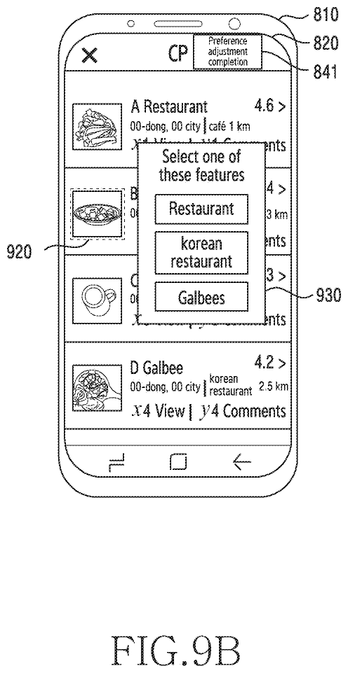

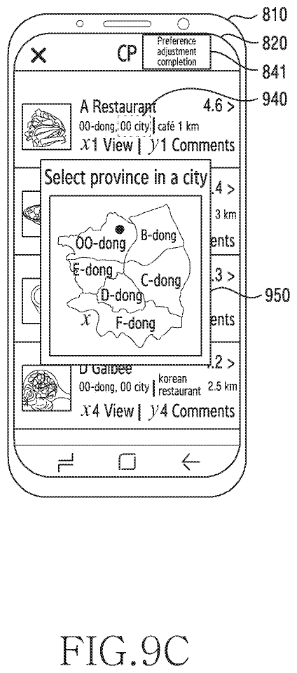

FIGS. 9A to 9C are example diagrams for explaining an operation in which an electronic device requests a user to select at least one of a plurality of attributes or features of an object selected by the user according to various embodiments of the disclosure. Below, an operation in which, in the user interface of the preference adjusting mode of FIG. 8B, the electronic device or the system requests the user to select at least one of the plurality of attributes or features of the object selected by the user.

Referring to FIG. 9A, in response to the user touching the score object 852 related with the B Galbee, the electronic device or the system may identify an attribute and feature of the score object 852. The attribute of the score object 852 may be integer type data of 0 to 5, and the feature of the score object 852 may correspond to the value (4.4) of the score object 852. A preference object may be related with the attribute and feature identified from the score object 852.

The electronic device or the system may request the user to select at least one of the plurality of attributes or features identified from the score object 852. For example, the electronic device may request the user whether the user prefers a value matching with the value (4.4.) of the score object 852, or whether the user prefers a value more than or less than the value (4.4) of the score object 852. Referring to FIG. 9A, an interface 910 requesting a selection of at least one of a plurality of features related with the score object 852 may be outputted on the user interface outputted to the display 820 of the electronic device 810. The interface 910 may be outputted to a location adjacent to the score object 852 selected by the user.

A preference object may be identified on the basis of a feature selected by the user in the interface 910. For example, in response to the user selecting ‘only 4.4’, the electronic device may identify that a user prefers the value (4.4.) of the score object 852. The preference object may be generated corresponding to the value (4.4) of the score object 852. In response to the user touching the preference adjusting completion button 841 and thus the operation mode being changed from the preference adjusting mode to the item display mode, the electronic device may change a sequence of a plurality of items according to whether an item matches with the value (4.4) of the score object 852. For example, at least one item having a score matching with the value (4.4) of the score object 852 may have higher order of priority than other items.

For another example, in response to the user selecting ‘<=4.4’, the electronic device may identify that the user prefers a score from 0 to 4.4. A preference object may include information about a section (score from 0 to 4.4) related with the score object 852. In response to the user touching the preference adjusting completion button 841 and thus the operation mode being changed from the preference adjusting mode to the item display mode, the electronic device may change a sequence of a plurality of items on the basis of the section (score from 0 to 4.4) corresponding to the preference object. For example, the plurality of items (B Galbee, C Beer and D Galbee in FIG. 9A) related with the section may have higher order of priority than other items (A restaurant).

For another example, in response to the user selecting ‘>=4.4’, the electronic device may identify that the user prefers a score from 4.4 to 5. A preference object may include information about a section (score from 4.4 to 5) related with the score object 852. In response to the user touching the preference adjusting completion button 841 and thus the operation mode being changed from the preference adjusting mode to the item display mode, the electronic device may change a sequence of a plurality of items on the basis of the section (score from 4.4 to 5). For example, the plurality of items (the A restaurant and the B Galbee in FIG. 9A) related with the section may have higher order of priority than other items (C Beer and D Galbee).

Referring to FIG. 9B, in response to the user touching an image object 920 related with the B Galbee, the electronic device may identify an attribute and feature of the image object 920. The image object 920, which is image or video data related with the B Galbee, may include one or more subjects related with the B Galbee. The electronic device may identify a feature of the image object 920 (for example, a plurality of subjects included in the image object 920 and/or a place where the image object 920 is captured). The electronic device may request the user to select a preferred subject or feature among the plurality of subjects included in the image object 920 or the plurality of features of the image object 920.

Referring to FIG. 9B, the request may be outputted on the display 820 of the electronic device 810 in the form of an interface 930. The interface 930 may include a kind of subject included in the image object 920 or a list related with a hashtag. A sequence of a plurality of features of the image object 920 in the interface 930 may be changed according to accuracy.

A preference object may be identified on the basis of any one of features of the image object 920 selected through the interface 930. For example, in response to the user selecting a ‘Korean restaurant’, a preference object may include information related with the image object 920 and the feature (Korean restaurant') selected by the user. In response to the user touching the preference adjusting completion button 841, while changing the operation mode, the speech response system may assign relatively high order of priority to an item including an image object related with the feature (‘Korean restaurant’) selected by the user. In the user interface, the sequence of the plurality of items may be changed on the basis of the assigned order of priority.

Referring to FIG. 9C, in response to the user touching an address object 940 of the A restaurant, the electronic device may identify an attribute and feature of the address object 940. The address object 940 may include data related with a GPS coordinate or address of the A restaurant. The electronic device may request the user to select a feature preferred by the user in the address object 940, on the basis of the feature of the address object 940.

Referring to FIG. 9C, the request may be outputted on the display 820 of the electronic device 810 in the form of an interface 950. The interface 950 may include a map corresponding to the address object 940. In response to the user selecting a preferred area on the interface 950, a preference object may include information related with the selected area.

In response to the user touching the preference adjusting completion button 841 after selecting A-dong and C-dong on the interface 950, the electronic device may assign relatively high order of priority to items (A restaurant, C Beer and D Galbee) existing in the A-dong and the C-dong among a plurality of items. The sequence of the plurality of items may be changed on the basis of the assigned order of priority. For example, the items (A restaurant, C Beer, and D Galbee) existing in the A-dong and the C-dong may be arranged on the user interface more preferentially than other items.

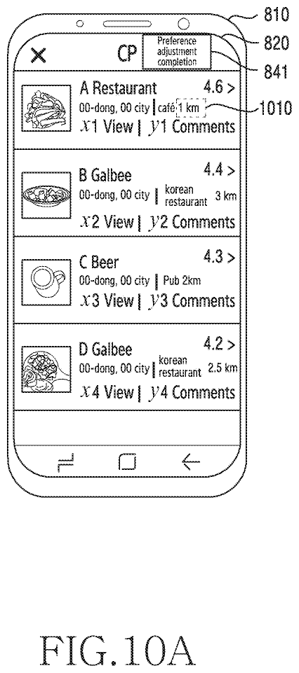

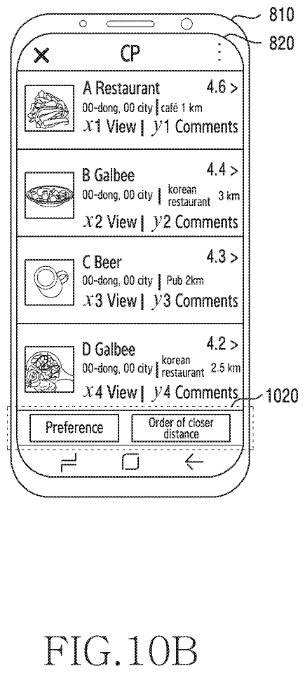

FIGS. 10A to 10B are example diagrams for explaining an operation in which an electronic device changes a sequence of arranging a plurality of items in the display 820 by using a preference object generated on the basis of a user input according to various embodiments the disclosure. Below, an operation in which the electronic device or the system changes the sequence of the plurality of items on the basis of an object selected by the user, in the user interface of the preference adjusting mode of FIG. 8B is explained.

Referring to FIG. 10A, in the preference adjusting mode, in response to selection of a distance object 1010 of the A restaurant by a user, the electronic device may identify the distance object 1010 as a preference object. The distance object 1010 is a value indicating a distance between the user and an item (A restaurant), so the preference object may include information related with the distance between the user and the item.

The user may touch the preference adjusting completion button 841 after touching the distance object 1010. In response to the touch of the preference adjusting completion button 841, an operation mode of the use interface may be changed from the preference adjusting mode to the item display mode.

Referring to FIG. 10B, after the operation mode is changed from the preference adjusting mode to the item display mode, a sequence of the plurality of items may be changed on the basis of a preference object. The preference object includes information related with the distance between the user and the item, so an item close to the user may have relatively high order of priority. The user interface may output a preference object related with the sequence of the plurality of items in at least a portion 1020 of the display 820. According to various embodiments, changing the sequence of the plurality of items on the basis of the preference object may be performed even before changing into the item display mode (for example, concurrently with the touch of the distance object 1010).

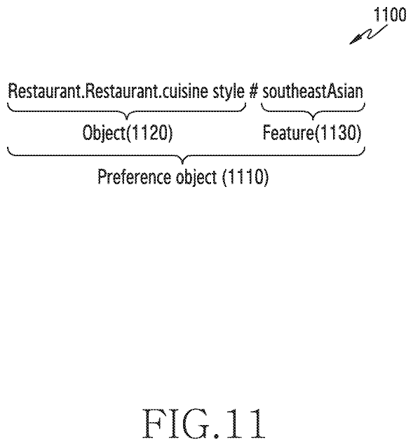

FIG. 11 is an example diagram 1100 for explaining a structure of a preference object 1110 managed by an electronic device or a system according to an embodiment of the disclosure.

The preference object 1110 may be information in which an object 1120 and a feature 1130 corresponding to the object 1120 are matched with each other. The object 1120 may be selected from a user on the basis of an operation explained in FIGS. 8B to 10A. Or, the object 1120 may be identified on the basis of a result of tracing log data.

The object 1120 may have values of various formats according to an attribute.

Referring to FIG. 11, the object 1120, which is an object included in an item related with a restaurant, may indicate a style of the restaurant. In this case, the object 1120 may have any one of a plurality of values (for example, “southeastAsian”, “American dinning” and “Korean traditional”) related with the style of the restaurant. In response to the object 1120 selected by the user having a specific value, a feature 1130 of the preference object 1110 may be identified as the specific value.

Referring to the operations explained in FIGS. 9A to 9C, the electronic device or the system may request the user to select a value preferred by the user, among the plurality of values that the object selected by the user may have. In this case, the feature 1130 of the preference object 1110 may be identified as the value selected by the user. The preference object 1110 may be stored in and managed by a database (for example, the user preference database 670 or system preference database 660 of FIG. 6) in the system.

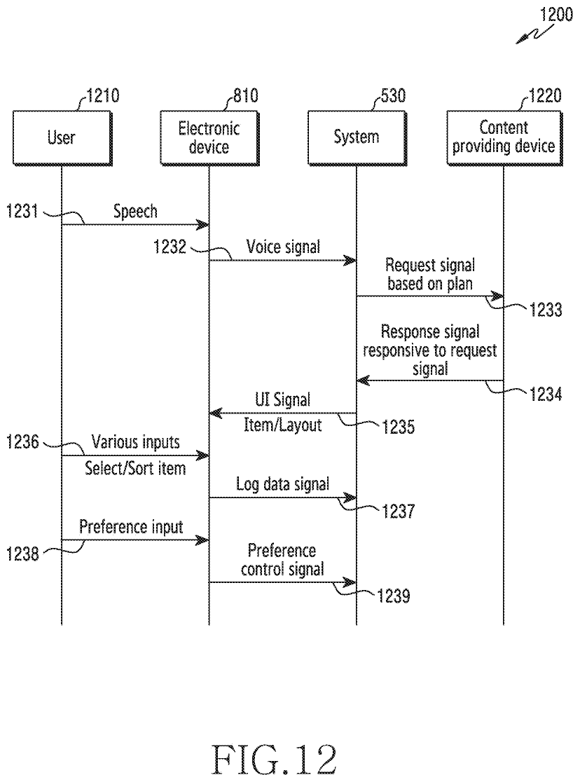

FIG. 12 is a signal flowchart 1200 for explaining interaction between an electronic device and a system according to an embodiment of the disclosure. According to some embodiments, the electronic device and the system may provide a user 1210 with a service corresponding to a speech 1231 of the user 1210. Electronic devices such as the electronic device 810, the system 530 and a content providing device 1220 may be coupled with each other through a wireless network or wired network. The system 530 may correspond to the system 530 of FIG. 5. The content providing device 1220 may correspond to any one of the plurality of content providing devices of FIG. 5. The electronic device 810 may correspond to any one of the plurality of content providing devices of FIG. 5.

Referring to FIG. 12, the user 1210 may input the speech 1231 to the electronic device 810. The speech 1231 may include a command for executing at least a portion of a function of the electronic device 810 or the system. For example, the speech 1231 may include a wake-up command. The wake-up command may be a command of converting a state of the electronic device 810 from an inactive state to an active state. The inactive state may represent a state in which at least one of functions of the electronic device 810 or constituent elements of the electronic device 810 is inactivated. The wake-up command may indicate the initiation of interaction between the user and the electronic device 810. The wake-up command may be a voice input used to activate a function for voice recognition of the electronic device 810 and the system 530.

The wake-up command may be configured with at least one designated or specified keyword such as “Hey, Bixby”. The wake-up command may be a voice input required for identifying whether it corresponds to the at least one keyword. The wake-up command may be a voice input which does not require natural language processing or requires natural language processing of a restricted level.

The speech 1231 may further include a voice command subsequent to the wake-up command. The voice command may be a command of requesting provision of a plurality of items from the electronic device 810 or the system 530 such as “Find hotels with 3 stars”. The voice command may be a command that is based on a natural language used by the user 1210. The voice command included in the speech 1231 may be recognized by the electronic device 810 or the system 530. Referring to FIG. 12, the electronic device 810 may transmit a voice signal 1232 corresponding to the speech 1231, to the system 530.

The system 530 may include a construction (for example, the speech recognition database 536 of FIG. 5) for recognizing the voice signal 1232. The system 530 may identify a text signal corresponding to the voice signal 1232. The system 530 may identify a voice command subsequent to the wake-up command, from the identified text signal. The system 530 may identify a plan of action that will be performed corresponding to the identified voice command. For example, the system 530 may identify the plan of action on the basis of the CAN database 535 of FIG. 5.

In response to the voice command being a command requesting provision of a plurality of items from the speech response system, the system 530 may communicate with the content providing device 1220 performing a search of the plurality of items, to identify the plurality of items. Referring to FIG. 12, the system 530 may transmit a request signal 1233 of requesting the provision of the plurality of items corresponding to the voice command, to the content providing device 1220. In response to there being a preference related with the plurality of items and generated before the input of the speech 1231, the request signal 1233 may include information related with the preference.

The content providing device 1220 may search a database (for example, the content database 544 of FIG. 5) in which an N number of items are stored, to identify an n (N>=n) number of items corresponding to a voice command. In response to the request signal 1233 including the information related with the preference, the content providing device 1220 may identify the n number of items satisfying the preference. The content providing device 1220 may transmit a response signal 1234 including information related with the identified n number of items, to the system 530. The response signal 1234, which is the information related with the n number of items, may include one or more objects corresponding to each of the n number of items. The response signal 1234 may include order of priority of the n number of items. In response to the request signal 1233 including the information related with the preference, the order of priority of then number of items included in the response signal 1234 may be set corresponding to the preference.

In response to reception of the response signal 1234, the system 530 may identify the n number of items included in the response signal 1234. In response to identifying of the n number of items included in the response signal 1234, the system 530 may generate a user interface (UI) signal 1235 that is information related with a user interface that will be provided to the user 1210 through the electronic device 810. The UI signal 1235 may include information related with the identified n number of items (for example, an object corresponding to each of the n number of items, and/or order of priority of the n number of items). The UI signal 1235 may include layout information related with an arrangement of objects in each of the n number of items.

In response to reception of the UI signal 1235, the electronic device 810 may output a user interface corresponding to the UI signal 1235, to the user 1210. On the user interface, the n number of items may be arranged according to a first sequence. The objects corresponding to each of the n number of items may be arranged in a region corresponding to each of the n number of items on the user interface, according to the layout information.

Referring to FIG. 12, the user 1210 may perform various inputs 1236 on the user interface. For example, in the item display mode, the user 1210 may sort the n number of items, or select at least one of the n number of items. Information related with the various inputs 1236 the user performs may be included in a log data signal 1237, and be transmitted from the electronic device 810 to the system 530.

The system 530 may include a database (for example, the user interaction log database 680 of FIG. 6) storing the information included in the log data signal 1237. By using the speech response system preference generator 622 of FIG. 6, the system 530 may, for example, identify a preference object form the log data signal 1237. From the various inputs 1236 the user performs, the system 530 may identify an object which the user is relatively more concerned with. The object identified by the system 530 may be identified as the preference object.

The user 1210 may change the operation mode of the user interface from the item display mode to the preference adjusting mode. The operation mode may be, for example, changed in response to a touch of the sub menu 840 of FIG. 8A. In the preference adjusting mode, the user 1210 may perform a preference input 1238 for directly selecting a preference object among objects outputted on the user interface.

Referring to FIG. 12, in response to the preference input 1238, the electronic device 810 may transmit a preference control signal 1239 related with a construction of the preference object, to the system 530. The preference control signal 1239 may include information (for example, an attribute of an object, and/or a feature of the object) related with the object selected by the user in the preference adjusting mode. After the user selects a specific object as the preference object, in order to generate the preference control signal 1239, the electronic device 810 may output the interface 910 of FIG. 9A to the user, to identify a feature related with the selected specific object.

In response to reception of the preference control signal 1239, the system 530 may store the identified preference object in a database (for example, the preference database 534 of FIG. 5 and/or the user preference database 670 of FIG. 6). In response to the number of preference objects stored in the database being 2 or more, a correlation between the preference objects or order of priority of the preference objects may be identified. For example, the preference sorter 625 of FIG. 6 may be used for identifying of the correlation between the preference objects or the order of priority of the preference objects.

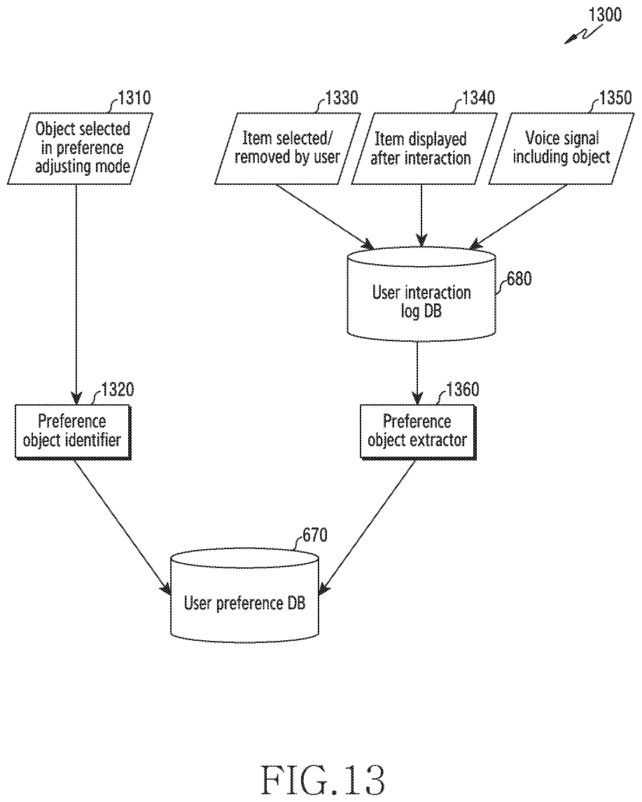

FIG. 13 is a diagram for explaining an operation in which a system identifies a preference from a user according to an embodiment of the disclosure. The operation of FIG. 13 may be performed by the system 530 of FIG. 5 or a hardware component or software component of FIG. 6. While a user interface including a plurality of items is forwarded to the user through an electronic device (for example, the first electronic device 520 of FIG. 5), the operation of identifying a preference of FIG. 13 may be performed. The plurality of items may be items that the system identifies in response to a user's voice command.

The user may perform an operation of changing a sequence of arranging the plurality of items in the user interface. The operation of changing the sequence of arranging the plurality of items may include an operation of excluding at least one of the plurality of items from the user interface, an operation of adding other items distinguished from the plurality of items to between the plurality of items arranged in sequence, and/or an operation of sorting the plurality of items on the basis of at least one of objects included in the plurality of items.

The system may collect interaction between a user related with a plurality of items included in a user interface and the user interface. The system may collect interaction related with a specific item selected by the user. The interaction collected by the system may include a user's operation of selecting or skipping a specific item, or a user's operation of browsing detailed information of the specific item.

Referring to FIG. 13, information related with interaction between a user and a user interface may be stored in the user interaction log database 680 of the system. The information 1300 stored in the user interaction log database 680 may include (1) information 1330 related with an item selected or removed by the user, among the plurality of items included in the user interface, (2) information 1340 related with an item remaining after various interaction of the user and the user interface, and (3) a voice signal 1350, which is inputted from the user, including a voice command related with an object.

By using the user interaction log database 680 or the preference object extractor 1360, the system may identify an operation in which the user changes a sequence of a plurality of items. The preference object extractor 1360 may identify an object related with an operation of changing the sequence. The preference object extractor 1360 may identify at least a portion of information included in the user's voice command, from the voice signal 1350. For example, in response to the user inputting a voice command such as “Find hotels with 2 stars” to the system, the preference object extractor 1360 may identify a value (2 stars in the example of the voice command) related with a specific object (a hotel class object divided by the number of stars in the example of the voice command) in the voice command.

By using the preference object extractor 1360, the system according to various embodiments may identify a preference object from information stored in the user interaction log database 680. A preference object identifier 1320 may correspond to a processor included in the electronic device or system or a thread executed in the processor. The preference object extractor 1360 may identify a frequency in which a specific object is used for sorting a plurality of items, and/or a probability in which the specific object is selected. The preference object extractor 1360 may identify a feature of the specific object on the basis of the identified frequency or probability.

The identified specific object and the feature related with the specific object may be used for generating of a preference object. In response to the feature of the specific object being identified in plural on the basis of the identified frequency or probability, the system may request the user to select at least one of the identified plurality of features. That the system requests the user to select at least one of the identified plurality of items may be performed, for example, on the basis of the operations of FIGS. 9A to 9C.

The user may change the operation mode of the user interface into the preference adjusting mode. By using the preference object identifier 1320, the system may identify the object 1310 selected by the user in the preference adjusting mode. The preference object identifier 1320 may correspond to a processor included in the electronic device or system or a thread executed in the processor.

In response to the identifying of the object 1310, the preference object identifier 1320 may identify one or more features related with the identified object 1310. In response to the plurality of features being identified with the object 1310, the preference object identifier 1320 may request the user to select at least one of the identified plurality of features. That the system requests the user to select at least one of the identified plurality of items may be performed, for example, on the basis of the operations of FIGS. 9A to 9C. By associating the object 1310 collected from the user and the feature related with the object 1310, the preference object identifier 1320 may generate information related with a preference object.

The information related with the preference object generated from the preference object identifier 1320 and the preference object extractor 1360 may be stored in the user preference database 670. The stored information related with the preference object may be used for identifying or changing the sequence of the plurality of items provided to the user.

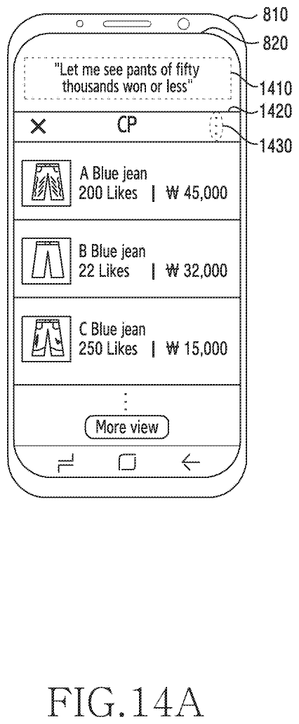

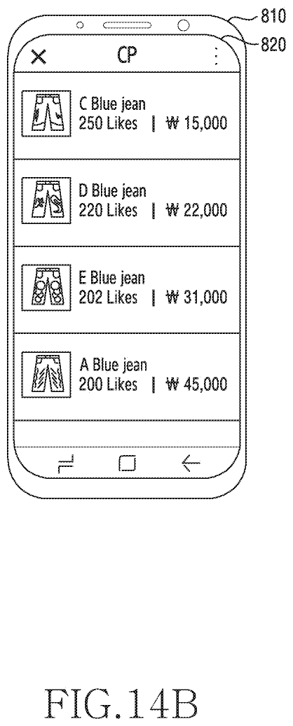

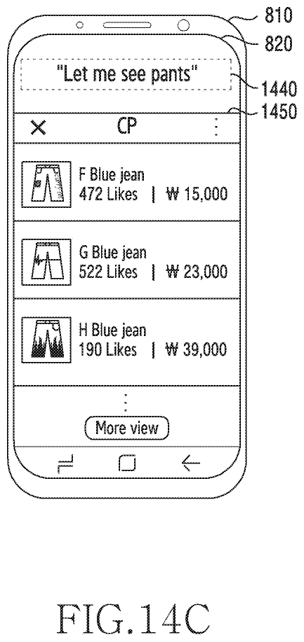

FIGS. 14A to 14C are diagrams for explaining an operation in which an electronic device changes a sequence of a plurality of items on the basis of a preference obtained from a user according to various embodiments of the disclosure. Referring to FIGS. 14A to 14C, a user interface including the plurality of items may be provided to the user through the display 820 of the electronic device 810.

It is assumed that the user inputs an utterance (for example, “Hey Bixby, let me see pants of fifty thousand won or less) including a voice command of searching one or more items to the electronic device 810. The utterance may include a wake-up command (“Hey, Bixby”) related with the electronic device 810 or the speech response system. Concurrently with that the wake-up command is identified, the electronic device 810 may transmit a voice signal inputted after the wake-up command, to an external electronic device that is an electronic device (for example, the system 530 of FIG. 5) recognizing a voice signal.

Referring to FIG. 14A, an example of a user interface outputted on the display 820 in response to the voice command is illustrated. In response to an utterance including the voice command, the electronic device 810 may display a text message 1410 as a visual object corresponding to a result of recognizing the voice command, on the user interface. The text message 1410 may be a feedback to recognition of the utterance. In response to the text message 1410 not coinciding with the voice command included in the user's utterance, the user may perform an operation for inputting again a voice command. The operation of inputting again the voice command may include, for example, an operation of touching a button (not shown) of activating a microphone of the electronic device 810.

In response to the voice command, the system may provide a user with a result of identifying or searching a plurality of items. The system may identify a condition of searching an item on the basis of an object included in the voice command. In the exemplified user's utterance (“Hey Bixby, let me see pants of fifty thousand won or less”), the system may identify a search condition (having a price of fifty thousand won) related with a kind (pants) of item and an object (a price object). The system may request a content providing device related with a corresponding item (for example, a content providing device of a clothing shopping service provider) to search the item corresponding to the search condition.

Referring to FIG. 14A, a list of searched plurality of items may be displayed in a partial region 1420 of a user interface on the display 820. In response to the list of the plurality of items being provided to the user through the display 820, a plurality of objects related with each of the plurality of items may be outputted in the format of a visual object (for example, a text object, an image object, and/or a video object) on the display 820.

In response to the list of the plurality of items being outputted through the display 820, visual objects related with each of the plurality of objects may be arranged on the display 820 on the basis of a layout generated from the electronic device or the system. Referring to FIG. 14A, regarding each item (pants), a visual object corresponding to each of a photo object, a price object, a name object and an evaluation object may be included in a layout. The layout may indicate a location of the visual object corresponding to each of the objects on the basis of an extensible markup language (XML) format. The layout may indicate some objects that will be outputted on the display 820 among all the objects related with the item (a photo object, a price object, a name object and an evaluation object among all objects related with an item (pants) in FIG. 14A).

The layout may be identified on the basis of at least one of (1) a content providing device providing a result of identifying a plurality of items, (2) a system storing preferences related with the plurality of items, and (3) the electronic device 810 identifying a region in which the visual object will be arranged on the display 820 on the basis of a state of the display 820. For example, while transmitting a result of identifying the plurality of items to the system, the content providing device may transmit a layout which is generated according to an intention of a content provider, to the system. The system may change the layout transmitted by the content providing device, on the basis of the preference, and transmit the changed layout to the electronic device 810. The system may change the layout wherein the visual object corresponding to the preference object is included in the layout or is emphasized. The electronic device 810 may additionally change the layout changed by the system on the basis of information related with a size and resolution of the display 820, and a region 1420 configured to display the plurality of items on the display 820 (for example, a size of the region 1420 and/or a form of the region 1420).

In the end, the layout may be generated or changed by at least one of not only a content providing device providing a service related with a search of a plurality of items but also a device (system) recognizing a voice command and a device (electronic device 810) directly performing interaction with the user. The sequence of the plurality of items outputted to the user may be also changed by not only the content providing device but also a device (system and electronic device) managing a user's preference.

For example, by touching a menu button 1430 of the region 1420 in which the plurality of items are displayed, the user may change the operation mode of the user interface into the preference adjusting mode. In the preference adjusting mode, in response to selection of the visual object by the user, the system may identify at least one of an object related with the selected visual object, an attribute of the object, and a feature of the object. The feature of the object may be identified by a user's input through the interfaces 910, 930 and 950 of FIGS. 9A to 9C, or log data related with the object.

According to some embodiments, the system may identify a preference object, from an activity that the user performs in another operation mode excepting for the preference adjusting mode. For example, from the user's utterance (“let me see pants of fifty thousand won or less), the system may identify a preference object (price object) and feature (having a price of fifty thousand won or less) for a specific item (pants). The identified preference object may be used for sorting a list of a plurality of items currently provided to the user.

FIG. 14B illustrates an example of a result in which a sequence of a plurality of items is changed corresponding to a preference identified from a user's input or user's log data. In response to the user inputting a price object as a preference object, the system may identify a feature of the selected price object, on the basis of a user's input through the interfaces 910, 930 and 950 of FIG. 9A to 9C, or a user's activity represented in log data related with the price object. For example, the system may identify, as the feature, a feature in which the user prefers a price object having a relatively less value.

Referring to FIG. 14B, in response to the user inputting the price object as the preference object, a list of a plurality of items may be sorted according to a feature related with the price object. The user prefers the price object having the relatively less value, so relatively high order of priority may be allocated to an item related with the price object having the relatively less value. In the list of the plurality of items displayed on the display 820, a sequence of the items may be identified or changed corresponding to order of priority. Referring to FIG. 14B, an item (C pants) whose price is cheapest may be arranged as the first one in the list of the plurality of items. That is, the plurality of items may be sorted in ascending order of a price.

The identified preference object may be stored in a specific database (for example, the preference database 534 of FIG. 5) of the system, and be used for performing a new operation according to a voice command newly inputted from a user. FIG. 14C illustrates an example of a user interface which is outputted to the user in response to a voice input (“let me see pants”) being newly inputted from the user after FIGS. 14A to 14B. The user interface may include a text message 1440 being a visual object of feeding back a result of recognizing a voice command, and an interface 1450 of feeding back a result of performing an operation corresponding to the voice command.

The operation corresponding to the voice command is an operation of searching a specific item (pants), and the voice command may not include an additional search condition other than the specific item. The system may identify a previously stored preference object related with an item included in the voice command. For example, the system may identify a preference object generated from a voice command (“let me see pants of fifty thousand won or less) previously inputted from the user, and a preference object (a price object having a relatively less value) that user selects in the preference adjusting mode. Referring to FIG. 14C, a plurality of items (pants) having a price of fifty thousand won or less may be outputted on the interface 1450 of the display 820 in ascending order of a price, on the basis of the identified at least one preference object.

As described above, the preference object may affect a plurality of search operations related with some item. In response to a plurality of content providing devices providing a search result related with the item, a preference object related with any one of the plurality of content providing devices may be used by other content providing devices.

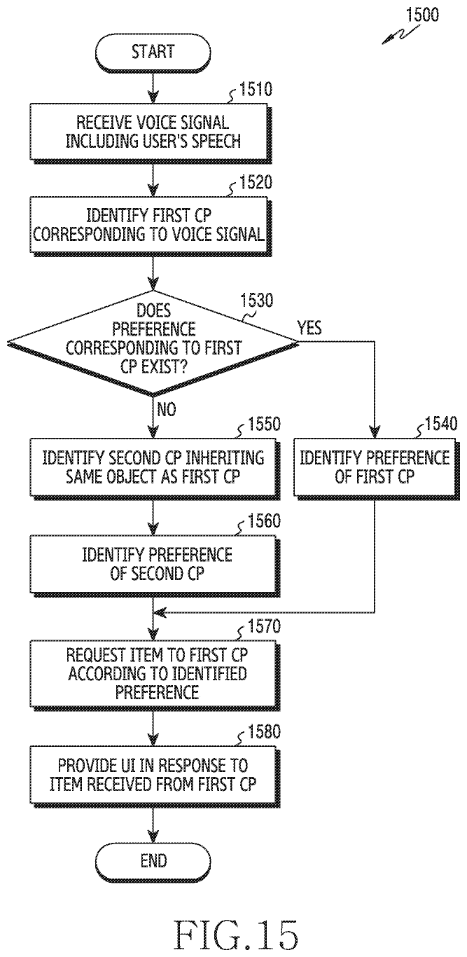

FIG. 15 is a diagram 1500 for explaining an operation in which a system coupled with a plurality of content providing devices shares a preference object related with any one of the plurality of content providing devices according to an embodiment of the disclosure. The operation of FIG. 15 may be performed by the system (for example, the system 530 of FIG. 5) coupled with the plurality of content providing devices and at least one electronic device.

At operation 1510, the system may receive a voice signal including a user's speech. The voice signal may be obtained from a user's electronic device (for example, the first electronic device 520 of FIG. 1 or the electronic device 810 of FIGS. 8A to 8C). The voice signal may include a voice command that is based on a user's natural language. The voice command may be related with an operation of searching at least one item.

At operation 1520, the system may identify a first content providing device (first CP) corresponding to the received voice signal. In response to the voice command being related with an operation of searching at least one item, the first content providing device may be a device of searching the item. The voice command may include an identifier of the first content providing device (for example, “Find a restaurant in a first content providing service”). That is, the system may identify the first content providing device (first CP) corresponding to a kind or identifier of item included in the received voice signal.

In response to identifying of the first content providing device, at operation 1530, the system may identify whether a preference corresponding to the first content providing device (first CP) exists. The preference corresponding to the first content providing device may be identified from a user's activity on a plurality of items searched in the first content providing device before receiving the voice signal. The preference corresponding to the first content providing device identified from the activity may be stored in a specific database (for example, the preference database 534 of FIG. 5) of the system. The preference may include information related with one or more preference objects. In response to the preference corresponding to the first content providing device existing, at operation 1540, the system may identify the preference.

In response to the preference corresponding to the first content providing device (first CP) not existing, at operation 1550, the system may identify a second content providing device (second CP) which inherits the same object as the first content providing device. Inheriting a specific object represents that mutually different content providing devices commonly use a format or data structure of the specific object. The object becoming a target of inheritance may be used in the form of a capsule in all of the first content providing device (first CP) and the second content providing device (second CP).

In response to identifying of the second content providing device (second CP), at operation 1560, the system may identify a preference of the identified second content providing device. By identifying the preference of the second content providing device, the system may identify an object related with the preference of the second content providing device, among the plurality of objects included in the item related with the first content providing device.

In response to identifying of the preference of the first content providing device or the preference of the second content providing device, at operation 1570, the system may request a search of an item to the first content providing device according to the identified preference. The search may be performed on the basis of the CAN database 535 of FIG. 5. The search may include information related with a preference object included in the identified preference. In response to identifying of the preference of the second content providing device, the preference object that the first content providing device and the second content providing device commonly make use of may be used for the item search. In response to the request, the first content providing device may search one or more items. The searched one or more items may be transmitted to the system.

In response to one or more items transmitted to the system, at operation 1580, the system may provide a user interface for outputting the one or more items, to the user. The user interface may include the one or more items and a visual object corresponding to at least one object included in each of the one or more items, according to a layout that is based on the identified preference.

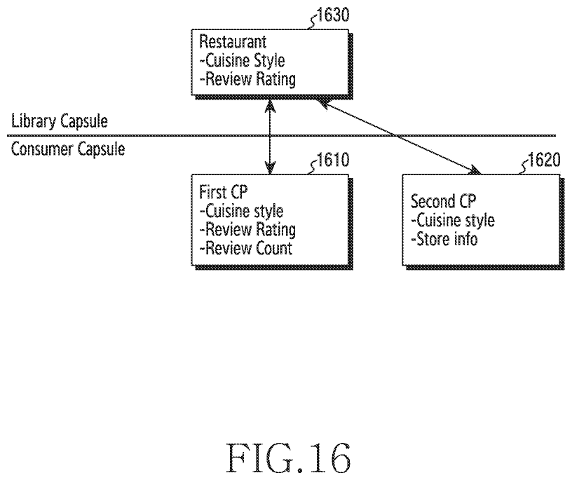

FIG. 16 is an example diagram for explaining an operation in which a system shares a preference between a plurality of content providing devices according to an embodiment of the disclosure.

A preference object may be generated or managed by the unit of capsule in which a plurality of objects are combined. The content providing device may generate a capsule which includes all objects related with a stored item. The speech response system may identify, as the preference object, an object which the user is relatively concerned with among the objects included in the capsule.

In response to managing the preference object by the unit of capsule, the system according to various embodiments may share a preference between mutually different capsules used by mutually different content providing devices. Referring to FIG. 16, an example operation of sharing the preference between the mutually different content providing devices (first content providing device (first CP) and second content providing device (second CP)) is illustrated. Referring to FIG. 16, a plurality of objects (CuisineStyle, ReviewRating and ReviewCount) related with an item of the first content providing device may be grouped into a first capsule 1610, and a plurality of objects (CuisineStyle and Storeinfo) related with an item of the second content providing device may be grouped into a second capsule 1620.

The system according to various embodiments may include an object which is shared by the mutually different content providing devices by using a capsule library. In a capsule, or between a plurality of capsules, a plurality of objects may have a hierarchical structure. In the capsule, at least one object included in the capsule and the capsule may have a hierarchical structure. Also, the plurality of capsules may have a hierarchical structure. In this case, an object defined in a capsule of an upper level may be inherited to a capsule of a lower level. The upper-level capsule may be identified from a capsule library that is a set of information related with a definition of the object or capsule. A capsule of a content providing device that uses an object defined in the upper-level capsule may be a lower-level capsule rather than an upper-level capsule. In response to a plurality of content providing devices commonly using an object defined in a specific capsule, the plurality of content providing devices may share the object commonly used.

The sharing of the capsule library and object may be performed by the system (for example, the preference exchanger 624 of FIG. 6). Referring to FIG. 16, a library capsule 1630 including objects (CuisineStyle and ReviewRating) related with a restaurant item included in the capsule library is illustrated. The first content providing device and the second content providing device may each inherit at least some of objects included in the library capsule 1630, to generate the first capsule 1610 and the second capsule 1620.

Referring to FIG. 16, at least one (for example, ReviewCount) of a plurality of objects included in the first capsule 1610 may be defined by the first content providing device. At least one (CuisineStyle and ReviewRating) of the plurality of objects included in the first capsule 1610 may be defined by an object included in the library capsule 1630.

Referring to FIG. 16, the second capsule 1620 used in the second content providing device may be generated by using a definition of a portion (CuisineStyle) of the objects included in the library capsule 1630. That is, the second capsule 1620 may include a partial object (CuisineStyle) among the objects included in the library capsule 1630.

The first capsule 1610 and the second capsule 1620 are defined by using one library capsule 1630, whereby at least one object may be shared between the first content providing device and the second content providing device. For example, the object (CuisineStyle) commonly used by the first capsule 1610 and the second capsule 1620 may be defined on the basis of the object (CuisineStyle) included in the library capsule 1630, thereby having a value of the same type. Even a preference or preference object related with the object (CuisineStyle) may be shared between the first content providing device and the second content providing device.

The sharing of the preference or preference object may be performed by the electronic device or process that manages the preference object in the speech response system (for example, on the basis of the system 530 of FIG. 5 and/or the preference exchanger 624 of FIG. 6). For example, it is assumed that the user searches a plurality of items by using the first content providing device, and the speech response system identifies, as a user's preference, a specific value (“chinesecusine”) related with a specific object (CuisineStyle) included in the first capsule 1610. In this case, the preference object may include information (for example, “CusinStyle.chinesecusine”) matching the specific object and the specific value.

In response to the preference object being identically defined in the plurality of capsules, the preference object may be shared in the plurality of capsules and a plurality of content providing devices corresponding to each of the plurality of capsules. The first capsule 1610 and the second capsule 1620 are defined using one library capsule 1630, so the preference object related with the object (CuisinStyle) used in common by the first capsule 1610 and the second capsule 1620 may be shared by each of the first content providing device and the second content providing device. A preference object (for example, the preference object including the “CusinStyle.chinesecusine”) identified from a user's activity on the plurality of items searched by the first content providing device may be used for searching and sorting items by using the second content providing device.

The sharing of the preference between the plurality of capsules may be performed by the capsule database 230 of the intelligence server 200 of FIG. 1. The capsule database 230 may be included as at least a portion of an electronic device (for example, the system 530 of FIG. 5) managing the preference. The capsule database 230 may transmit a preference object related with any one (for example, the first content providing device) of the plurality of content providing devices, to a content providing device that uses an object corresponding to the preference object, among other content providing devices.

For example, a preference object (for example, the preference object including the “CusinStyle.chinesecusine”) identified from the user's activity on the plurality of items searched by the first content providing device may be transmitted to the capsule database 230. Additional information (for example, a user's delivery food preference) related with the preference object may be transmitted to the capsule database 230, together. The capsule database 230 may identify that the object (CusinStyle) related with the preference object is an object included in the library capsule 1630. The capsule database 230 may identify the first capsule 1610 and the second capsule 1620 which inherit the library capsule 1630. The capsule database 230 may use the preference object for searching of an item of the second content providing device corresponding to the identified second capsule 1620.

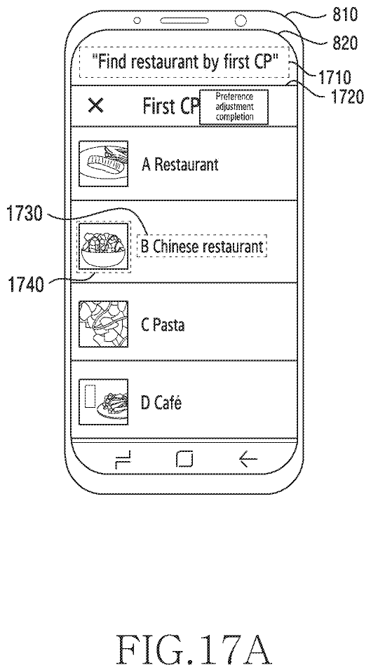

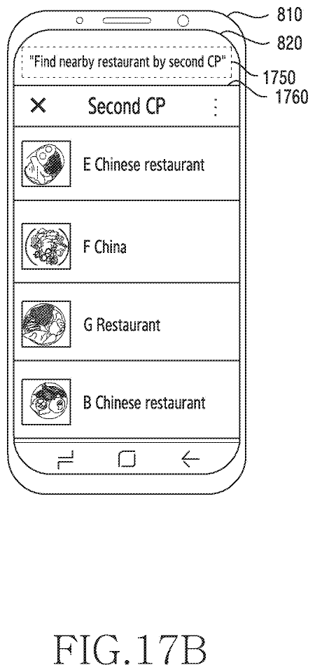

FIGS. 17A to 17B are example diagrams for explaining an operation in which an electronic device shares a preference between a plurality of applications related with each of a plurality of content providing devices according to various embodiments of the disclosure.

Referring to FIG. 17A, a user may input a first voice command related with a search of a specific item (restaurant) by the first content providing device, to the electronic device 810 of a speech response system. The first voice command may include a command of using the first content providing device for searching of an item. The electronic device 810 may output a result of recognizing the first voice command on the display 820 in the form of a text message 1710.

In response to input of the first voice command, the electronic device 810 may output a result of searching a plurality of items from the first content providing device on the display 820. A list of the plurality of items may be outputted to at least a partial region 1720 of the display 820. A sequence of the plurality of items outputted to the region 1720 may be a first sequence that is based on a previously generated preference object. A visual object corresponding to at least one object related with the plurality of items in the region 1720 may be arranged according to a first layout. Referring to FIG. 17A, a visual object 1730 corresponding to a name object of an item and a visual object 1740 corresponding to an image object of the item may be included in the partial region 1720 in which the plurality of items are outputted.

In response to output of the plurality of items, the user may perform various activities related with the plurality of items. The activity may include an operation of sorting the plurality of objects in ascending order or descending order of a specific object (for example, a price object), and an operation of selecting or removing at least one of the plurality of items. The activity may include an operation of inputting the preference object to the electronic device. The operation in which the user inputs the preference object may be performed, for example, on the basis of the operations explained in FIGS. 9A to 10B.

The user may switch an operation mode of a user interface outputting a plurality of items, between the preference adjusting mode and the item display mode. In the item display mode, in response to a user's touch to any one of the visual objects 1730 and 1740, the electronic device 810 may output detailed information of an item corresponding to any one of the touched visual objects 1730 and 1740 on the display 820.

In the preference adjusting mode, in response to a user's touch to any one of the visual objects 1730 and 1740, the electronic device 810 may identify a preference object related with the touched any one of the visual objects 1730 and 1740 on the display 820. Referring to FIG. 17A, the user may touch at least a portion of the visual object 1730 corresponding to the name object. For example, the user may select only a “Chinese food” portion of the visual object 1730 by using a drag gesture. In this case, the electronic device or system may identify that the user is interested in an item having a name including “Chinese food”. In response to the identifying, the electronic device or the system may match the name object and the “Chinese food”, to generate a preference object.

For another example, the user may touch at least a portion of the visual object 1740 corresponding to the name object. The electronic device or the system may identify that the user is interested in an item which includes an image object similar with an image object the user selects (or an image object including a feature of the image object the user selects), on the basis of a feature (for example, a kind of food subject included in an image) of the touched image object. The electronic device or the system may match the image object and the feature, to generate the preference object.

The generated preference object may be personalized to a user. The preference object may be used for not only a search of an item using a first content providing device but also a search of an item for which the user uses the second content providing device. Referring to FIG. 17B, the user may input a second voice command related with a search of a specific item (restaurant) by a second content providing device, to the electronic device 810 of the speech response system. The electronic device 810 may output a result of recognizing the second voice command in the form of a text message 1750 on the display 820.

The second voice command may be inputted after input of the first voice command. In this case, an activity that the user performs corresponding to the first voice command and a preference object generated on the basis of the activity may be used for a search of an item corresponding to input of the second voice command. For example, in response to the user selecting the visual object 1730 and inputting that the user is interested in an item having a name including “Chinese food” to the electronic device 810, the system may request the second content providing device to search the item having the name including “Chinese food” in response to input of the second voice command. The request may be performed on the basis of an operation related with sharing of the preference object explained in FIGS. 15 to 16.

Referring to FIG. 17B, as the preference object related with the first voice command is shared, although a command of searching the item having the name including “Chinese food” is not included in the second voice command, the item having the name including “Chinese food” may have relatively high order of priority among the plurality of items provided by the second content providing device.

When a plurality of items provided by the second content providing device are outputted by at least the partial region 1760 of the display 820, an item having relatively high order of priority (the item having the name including “Chinese food”) among the plurality of items may be outputted preferentially.

FIGS. 18A to 18B are example diagrams for explaining an operation in which an electronic device outputs a preference object to a user according to various embodiments of the disclosure.

Referring to FIG. 18A, in response to a user inputting a voice command of searching at least one item to the electronic device 810, the electronic device 810 may output a result of recognizing the voice command in the form of a text message 1810 on the display 820 of the electronic device 810. Below, it is assumed that the user inputs a voice command (“Find a hotel in San Jose under $400 for Thanksgiving weekend”) including a search condition related with a hotel item.

The system may communicate with at least one content providing device on the basis of the recognized voice command, to search a user's voice command and one or more hotel items. The operation of searching the item may be identified on the basis of a preference object generated by a user's past activity. The operation of searching the item may be performed on the basis of a search condition included in the voice command.

By matching a specific object and an attribute of the specific object, the search condition may be generated on the basis of a format similar with a preference object. For example, from the voice command, the search condition may be generated by matching a location object and a specific location (San Jose). Also, from the voice command, the search condition may be generated by matching a price object and a specific price range ($400 or less). Also, from the voice command, the search condition may be generated by matching a period object and a specific time range (Thanksgiving weekend). The search condition inputted from the voice command may be used for generation of the preference object.

In the end, the content providing device may search the preference object and one or more items satisfying one or more search conditions. Referring to FIG. 18A, the system may provide a result of identifying the one or more items in response to a voice command to a user through the electronic device 810. A result of identifying the one or more items or a result of performing the voice command may be provided to the user through a partial region 1820 on the display 820.

The electronic device 810 or the system may output a search condition or preference object which is used for a search of an item, to the user. Referring to FIG. 18A, the preference object used for the item search may be provided to the user through a partial region 1830 on the display 820. In response to the user touching the partial region 1830, the electronic device 810 may, as in FIG. 18B, output detailed information of the preference object on the display 820. Referring to FIG. 18B, a preference object generated from the user's voice command may be outputted to a partial region 1850 of the display 820, and a preference object generated before input of the voice command may be outputted to a partial region 1840 of the display 820.

In an example user interface of FIG. 18B, the user may change one or more preference objects outputted. For example, the user may change an attribute of a preference object related with WiFi support or non-support, among the plurality of preference objects illustrated in FIG. 18B. The user may touch an interface related with a star ranking on the example user interface of FIG. 18B, to change an attribute of the preference object related with the star ranking.

FIG. 19 is a diagram illustrating an example of a user interface (UI) that an electronic device provides to a user in order to identify a preference object according to an embodiment of the disclosure.

Referring to FIG. 19, the electronic device may output a UI 1910 to the user. The UI 1910 may include a list of items previously provided to the user and/or a visual object for identifying an object from the user. For example, referring to FIG. 19, the electronic device may output visual objects related with objects (star rating, amenities, and room type) related with a hotel, in the UI 1910. The user may select a visual object related with an object intended to input a preference, among the visual objects corresponding to each of the objects outputted in the UI 1910.

For example, in response to the user touching a region 1911 in a visual object related with an amenity object, the electronic device may output a UI 1920 for identifying an attribute preferred by the user among one or more attributes included in the amenity object. The one or more attributes included in the amenity object may be identified from the electronic device or the system (for example, the system 530 of FIG. 5) coupled to the electronic device. Referring to FIG. 19, the electronic device may output, in the UI 1920, a visual object corresponding to each of the attributes (non-smoking, pet friendly, and breakfast included) included in the amenity object. The electronic device may output, in the UI 1920, a visual object (for example, a like button) for receiving a user's selection related with at least one of a plurality of attributes included in the amenity object.

Referring to FIG. 19, the user may touch, in the UI 1920, visual objects 1921 and 1922 corresponding to each of non-smoking and pet friendly. In response to touch of the visual objects 1921 and 1922, the electronic device may identify that the user relatively prefers a non-smoking and pet friendly hotel. In response to touch of the visual objects 1921 and 1922, the electronic device may provide a feedback of notifying that attributes related with the selected visual objects 1921 and 1922 are included in a preference (for example, a UI 1930). The electronic device may transmit the attributes (for example, non-smoking and pet friendly) selected by the user among the plurality of attributes included in the amenity object, to the system coupled with the electronic device.

The electronic device may output, in the UI 1920, a visual object 1923 related with ending or conversion of the UI 1920. In response to the user touching the visual object 1923 or a visual object 1924 floated in the UI 1920 or on the UI 1920 by an operating system, the electronic device may finish displaying the UI 1920, and return to a UI (for example, the UI 1910) that is outputted before the outputting of the UI 1920. Because the electronic device has identified the preference from the user on the basis of the UI 1920, the electronic device may change the displaying of the UI 1910 to return on the basis of a result of identifying the preference.

Referring to FIG. 19, a UI 1930 outputted after identifying the preference from the user on the basis of the UI 1920 is illustrated. The electronic device may output, in the UI 1930, a visual object 1931 corresponding to attributes selected by the user. In response to the user searching a hotel after outputting of the UI 1930, the electronic device and the system coupled with the electronic device may search the hotel on the basis of the object (amenity object) selected through the UI 1920 and the attributes (non-smoking and pet friendly) selected by the user. A combination (for example, a preference object) of the object and attribute identified through the UI 1920 may be, for example, shared between a plurality of content providing services related with the search of the hotel, on the basis of the description made in FIG. 15 to FIG. 16.

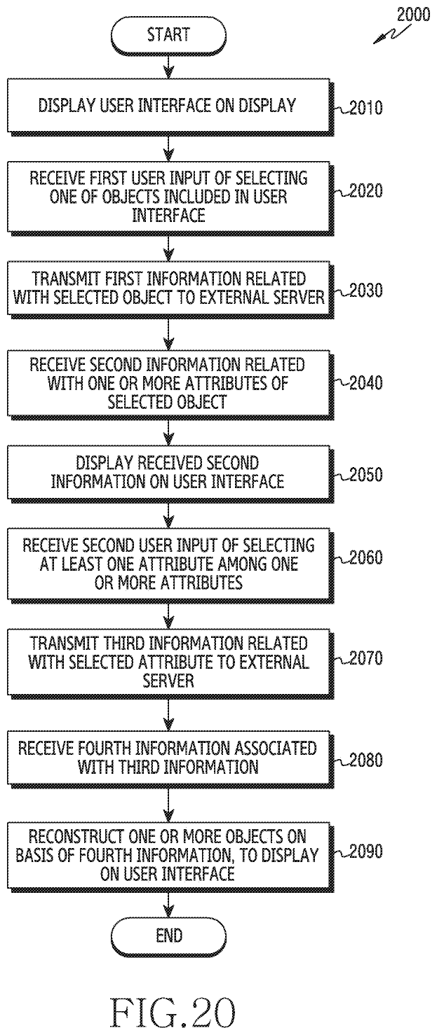

FIG. 20 is a flowchart 2000 for explaining an operation of an electronic device according to an embodiment of the disclosure. The electronic device of FIG. 20 may, for example, correspond to the first electronic device 520 of FIG. 5.

Referring to FIG. 20, at operation 2010, the electronic device according to various embodiments may display a user interface (UI) on a display wherein the user interface includes one or more objects. The UI displayed on the display may be identified from an application program stored in a memory of the electronic device. The application program may correspond to a voice based assistance program.

Referring to FIG. 20, at operation 2020, the electronic device according to various embodiments may receive a first user input of selecting one object among the objects included in the UI. For example, the first user input may be related with the user input explained in FIGS. 8A to 8C. For example, the first user input may be related with an input of changing the operation mode into the preference adjusting mode or selecting one or more objects among a plurality of objects in the preference adjusting mode.

Referring to FIG. 20, at operation 2030, the electronic device according to various embodiments may transmit first information related with the selected object to an external server, through a communication circuitry. The first information may include at least one of a name of an object and an attribute related with the object. The external server of FIG. 20 may correspond to the system 530 of FIG. 5.

Referring to FIG. 20, at operation 2040, the electronic device according to various embodiments may receive second information about one or more attributes of the selected object from the external server (for example, a system coupled with the electronic device), through the communication circuitry. The second information may include a plurality of attributes identified from the system and related with the object.

Referring to FIG. 20, at operation 2050, the electronic device according to various embodiments may display the received second information on the UI. For example, as in FIGS. 9A to 9C, the electronic device may output, on the display, at least one of the interfaces 910, 930 and 950 for selecting at least one of the attributes included in the second information.

Referring to FIG. 20, at operation 2060, the electronic device according to various embodiments may receive a second user input of selecting at least one attribute among the attributes displayed on the UI. For example, the user may select at least one of the plurality of attributes related with the object selected by the first user input, on the basis of the interfaces 910, 930 and 950 of FIGS. 9A to 9C.

Referring to FIG. 20, at operation 2070, the electronic device according to various embodiments may transmit third information related with the selected attribute to the external server, through the communication circuitry. The external server to transmit the third information may correspond to the external server of operation 2030. The third information may include a parameter for identifying the attribute selected by the user.

Referring to FIG. 20, at operation 2080, the electronic device according to various embodiments may receive fourth information associated with the third information from the external sever. The fourth information may be related with information (for example, a preference object) matching the object and the attribute which are identified in the first user input and the second user input, respectively.

Referring to FIG. 20, at operation 2090, the electronic device according to various embodiments may reconstruct one or more objects, based at least partly on the fourth information, and display the reconstructed objects on the user interface. For example, the electronic device may change at least one of a layout or sequence of the objects included in the UI which is outputted on the display at operation 2010, on the basis of the fourth information. The fourth information may include a score that is based at least partly on the attributes of the one or more objects included in the UI. In response to searching a plurality of items, the electronic device may sort the searched plurality of items from a preference object having the highest score among a plurality of preference objects, on the basis of one or more scores included in the fourth information.

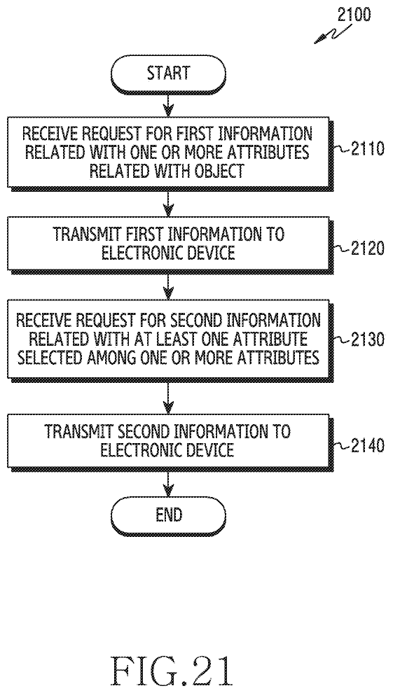

FIG. 21 is a flowchart 2100 for explaining an operation of a system according to an embodiment of the disclosure. The system may correspond to a device (for example, an external server) coupled with the electronic device of FIG. 20 by a wireless or wired network.

Referring to FIG. 21, at operation 2110, the system according to various embodiments may receive a request for first information about one or more attributes related with an object, from an electronic device coupled with the system. The electronic device coupled with the system may, for example, display a UI including one or more objects on the display, on the basis of operation 2010 of FIG. 20. The request may be related with one or more objects selected by a user of the electronic device among the objects displayed in the UI. The request may be received through a communication interface (for example, the communication interface 531 of FIG. 5) included in the system. The request may be related with the first information of operation 2030 of FIG. 20.

In response to the request for the first information received from the electronic device, at operation 2120, the system according to various embodiments may transmit the first information to the electronic device through the communication interface. The first information may include one or more attributes related with the one or more objects selected by the user of the electronic device. The first information may be related with the second information of operation 2040 of FIG. 20. The electronic device receiving the first information of operation 2120 may output an interface (for example, the interfaces 910, 930 and 950 of FIGS. 9A to 9C) for selecting the one or more attributes included in the first information, to the user.

Referring to FIG. 21, at operation 2130, the system according to various embodiments may receive, from the electronic device, a request for second information related with at least one attribute selected by the user among the one or more attributes included in the first information. The system may receive the request for the second information through the communication interface. The request for the second information may be, for example, generated by the electronic device on the basis of operation 2060 to operation 2070 of FIG. 20. The request for the second information may include information for identifying the one or more attributes selected by the user of the electronic device.

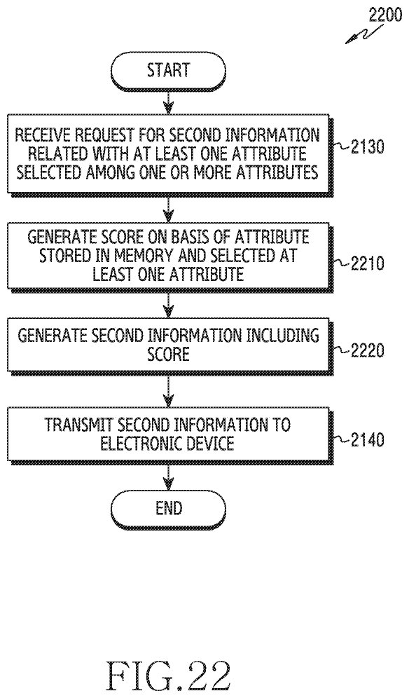

In response to the request for the second information received from the electronic device, at operation 2140, the system according to various embodiments may transmit the second information to the electronic device through the communication interface. An operation in which the system obtains the second information is explained in more detail with reference to FIG. 22. The electronic device may, for example, receive the second information on the basis of operation 2080 of FIG. 20.

FIG. 22 is a flowchart 2200 for explaining an operation in which a system obtains a score related with an attribute of an object identified from a user of an electronic device according to an embodiment of the disclosure. The system of FIG. 22 may correspond to the system of FIG. 21.

Referring to FIG. 22, at operation 2130, the system according to various embodiments may receive, from the electronic device, a request for second information related with at least one attribute selected by the user among one or more attributes included in first information. Operation 2130 of FIG. 22 may correspond to operation 2130 of FIG. 21. The request for the second information may include information for identifying the attribute selected by the user and an object corresponding to the selected attribute.

Referring to FIG. 22, at operation 2210, the system according to various embodiments may generate a score, based at least partly on an attribute previously designated and stored in a memory and the selected at least one attribute. The score may be related with identifying whether to use information (for example, a preference object) matching the attribute selected by the user and the object corresponding to the selected attribute, when sorting a list of items that will be provided to the user. For example, when sorting a plurality of items searched in response to a user request, the electronic device or system according to various embodiments may select a preference object that will be used for sorting of the plurality of items, on the basis of respective scores of a plurality of preference objects related with the plurality of items.

Referring to FIG. 22, at operation 2220, the system according to various embodiments may generate second information including the score. Referring to FIG. 22, at operation 2140, the system according to various embodiments may transmit the second information to the electronic device. The generated score may be transmitted, as a portion of the second information, to the electronic device. Operation 2140 of FIG. 22 may correspond to operation 2140 of FIG. 21.

According to various embodiments, in response to a user's voice command related with a search of an item, the electronic device and the system may search one or more items. In response to the plurality of items being searched, the plurality of items arranged according to a first sequence may be provided to a user through a user interface of the electronic device. By controlling the user interface, the user may perform various activities related with the plurality of items. The plurality of items may each include a plurality of objects. The electronic device and the system may identify an object that is used when the user identifies at least one item (for example, an item the user prefers) among the plurality of items from the activity. By matching the identified object and a feature of the identified object, the electronic device and the system may identify a user's preference related with a search of an item. The identified preference may be used for sorting of the plurality of items. For example, the preference may be used for changing a sequence in which the plurality of items are arranged on the user interface, from the first sequence to the second sequence. For example, in response to the user inputting a new voice command, the preference may be used for searching an item in response to the new voice command.

Methods of embodiments mentioned in the claims or specification of the disclosure may be implemented in the form of hardware, software, or a combination of the hardware and the software.

In response to being implemented by the software, a computer-readable storage media storing one or more programs (i.e., software modules) may be provided. The one or more programs stored in the computer-readable storage media are configured to be executable by one or more processors within an electronic device. The one or more programs include instructions for enabling the electronic device to execute the methods of the embodiments stated in the claims or specification of the disclosure.

These programs (i.e., software modules and/or software) may be stored in a random access memory (RAM), a non-volatile memory including a flash memory, a read only memory (ROM), an electrically erasable programmable ROM (EEPROM), a magnetic disc storage device, a compact disc-ROM (CD-ROM), digital versatile discs (DVDs), an optical storage device of another form, and/or a magnetic cassette. Or, the programs may be stored in a memory that is constructed in combination of some or all of them. Also, each constructed memory may be included in plural as well.

Also, the program may be stored in an attachable storage device that may access through a communication network such as the Internet, an intranet, a local area network (LAN), a wireless LAN (WLAN) or a storage area network (SAN), or a communication network configured in combination of them. This storage device may connect to a device performing an embodiment of the disclosure through an external port. Also, a separate storage device on the communication network may connect to the device performing the embodiment of the disclosure as well.

In the above-described concrete embodiments of the disclosure, constituent elements included in the disclosure have been expressed in the singular or plural according to a proposed concrete embodiment. But, the expression of the singular or plural is selected suitable to a given situation for the sake of description convenience, and the disclosure is not limited to singular or plural constituent elements. Even a constituent element expressed in the plural may be constructed in the singular, or even a constituent element expressed in the singular may be constructed in the plural.

An electronic device of various embodiments and a method performed by the electronic device may sort a plurality of items on the basis of a feature of a visual object selected by a user.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a display;
at least one communication circuitry;
a microphone;
at least one speaker;
at least one processor operatively coupled to the display, the communication circuitry, the microphone, and the speaker; and
at least one memory electrically coupled to the at least one processor,
wherein the memory is configured to store an application program comprising a user interface, and
wherein the memory stores instructions, when executed, enables the at least one processor to:
display the user interface on the display wherein the user interface comprises one or more objects, and receive a first user input of selecting one object among the objects,
transmit first information related to the selected object to an external server, through the communication circuitry,
receive second information about one or more attributes of the selected object from the external server, through the communication circuitry, to display the received second information on the user interface,
receive a second user input of selecting at least one attribute among the attributes, and
transmit third information related to the selected attribute to the external server, through the communication circuitry.

2. The electronic device of claim 1, wherein the instructions further enable the at least one processor to:
receive fourth information associated with the third information from the external server, through the communication circuitry; and
reconstruct the one or more objects, based at least partly on the fourth information, to display the reconstructed objects on the user interface.

3. The electronic device of claim 2, wherein the fourth information comprises a score which is based at least partly on the attributes of the one or more objects comprised in the user interface.

4. The electronic device of claim 1, wherein the application program comprises a voice based assistance program.

5. The electronic device of claim 2, wherein the instructions further enable the at least one processor to arrange the one or more objects, which are arranged on the basis of a first layout in the user interface, in the user interface on the basis of a second layout related with the received fourth information.

6. The electronic device of claim 1,
wherein the instructions further enable the at least one processor to output a visual object for reconstruction of the objects in the user interface, and
wherein the first user input is received after reception of a user input related with the visual object.

7. The electronic device of claim 1, wherein the instructions further enable the at least one processor to:
in response to selection of an object related with an image among the objects by the first user input, transmit the first information comprising a request for obtaining an attribute of the image to the external server; and
in response to reception of the second information related with the first information comprising the request for obtaining the attribute of the image, display one or more attributes related with the image comprised in the second information on the user interface.

8. A system comprising:
a communication interface;
at least one processor operatively coupled with the communication interface; and
at least one memory electrically coupled to the at least one processor, wherein the memory stores instructions, when executed, enables the at least one processor to:
receive, from an electronic device displaying a user interface comprising one or more objects on a display, a request for first information about one or more attributes related with an object selected among the objects, through the communication interface,
in accordance with the request for the first information, transmit the first information to the electronic device through the communication interface,
receive a request for second information related with at least one attribute selected among the one or more attributes, from the electronic device through the communication interface, and
in accordance with the request for the second information, transmit the second information to the electronic device through the communication interface.

9. The system of claim 8, wherein the instructions further enable the at least one processor to:
receive the request for the second information;
generate a score, based at least partly on an attribute already designated and stored in the memory and the selected at least one attribute; and
transmit the score as at least part of the second information, to the electronic device.

10. The system of claim 8, wherein the second information comprises information for reconstructing the one or more objects comprised in the user interface displayed in the electronic device.

11. The system of claim 8, wherein the first information comprises information for constructing a user interface for selecting at least one of the one or more objects, from a user of the electronic device.

12. The system of claim 8, wherein the instructions further enable the at least one processor to, in response to reception of the request for the first information about attributes of an object comprising an image among the objects, transmit the first information comprising the one or more attributes related with the image to the electronic device.

13. An electronic device comprising:
a microphone;
a memory;
a display; and
at least one processor operatively coupled to the microphone, the memory, and the display,
wherein the at least one processor is configured to:
receive a user's utterance through the microphone,
in response to the utterance, display, on the basis of a first sequence, a plurality of items in a user interface outputted in the display, the plurality of items each comprising at least one visual object, the user interface comprising at least one executable object displayed together with the plurality of items and for changing the first sequence,
in a designated operation mode of the user interface, in response to a user's input of selecting the at least one executable object, display, in the user interface, the plurality of items on the basis of a second sequence indicated by the selected object, and
in the designated operation mode, in response to a user's input of selecting any one visual object among the at least one visual object, display, in the user interface, the plurality of items on the basis of a third sequence distinguished from the first sequence and the second sequence.

14. The electronic device of claim 13, wherein, in response to the user's input of selecting a visual object corresponding to an image object of any one of the plurality of items among the visual objects, the at least one processor is further configured to output, to the user interface, a list comprising a plurality of features identified in the image object.

15. The electronic device of claim 14, wherein the at least one processor is further configured to:
in response to a user's input of selecting at least one of the plurality of features, identify one or more items comprising an image object related with the feature among the plurality of items; and
identify the third sequence wherein the one or more items comprising the image object related with the feature have a relatively high order of priority among the plurality of items.

16. The electronic device of claim 13, wherein the at least one processor is further configured to:
in response to the user's input of selecting any one of the at least one visual object, identify an object corresponding to the selected visual object and a feature of the selected visual object; and
on the basis of the identified object and feature, request a second electronic device coupled to the electronic device to transmit information related with the third sequence which is used for changing a sequence of the plurality of items.

17. The electronic device of claim 16, wherein the second electronic device generates the third sequence, on the basis of a preference object comprising information matching the identified object and feature.

18. The electronic device of claim 17, wherein the second electronic device generates information for changing an arrangement of the visual object in the user interface, on the basis of the preference object.

19. The electronic device of claim 13,
wherein the visual object corresponds to any one of objects related with each of the plurality of items, and
wherein the third sequence is a sequence of sorting again the plurality of items on the basis of an object corresponding to the selected visual object.

20. The electronic device of claim 13, wherein the at least one processor is further configured to, in response to touch of the at least one visual object that is related to hotel selection, identify that the user relatively prefers at least one of a non-smoking or pet friendly hotel.
